(19) United States
(12) Patent Application Publication
(10) Pub. No.: US 2014/0172615 A1
(43) Pub. Date: Jun. 19, 2014

(54) Method for Transparent and Fair Resource Distribution

(71) Applicant: Christopher R. Major, Manhattan Beach, CA (US)

(72) Inventor: Christopher R. Major, Manhattan Beach, CA (US)

(21) Appl. No.: 14/106,708

(22) Filed: Dec. 13, 2013

Related U.S. Application Data
(60) Provisional application No. 61/736,667, filed on Dec. 13, 2012.

(51) Int. Cl. G06Q 30/08

(52) U.S. Cl. CPC G06Q 30/08
USPC 705/26.3

(57) ABSTRACT

A computer-implemented system for allocation of a series of picks amongst multiple selectors in a selection process is configured to use total picks data, number of selectors data, and picks per selector data to determine a series of benchmark pick slots for each selector in accordance with a benchmark, for each selector, calculating a pick cost for awarding a pick position to the selector, awarding said pick position to the selector for whom the pick cost would least deviate the system from the benchmark and storing said pick cost of awarding said pick, and then iterating through the remainder of the draft using pick cost to determine who picks next, ensuring maximum fairness in the pick order. The system also manages the draft itself once the pick order is determined. It can assign value to the items chosen. It awards, or deducts, points from participants based upon their receiving picks that are better or worse than they should have, and for the quality of the items they have chosen.

### CROSS-REFERENCE TO RELATED APPLICATIONS

This application claims priority to U.S. Provisional Patent Application No. 61/736,667, filed on Dec. 13, 2012, entitled “SYSTEM AND METHOD FOR VALUE-BASED SCHEDULING,” the entirety of which is incorporated herein by reference.

### BACKGROUND OF THE INVENTION

Resources are distributed amongst individuals, companies, and teams by a variety of fashions. They go to the highest bidder, first come first serve, first come first serve but with a limit on how many can be purchased and so on. None of these process would be regarded as fair. And even if they were, none of these processes offer transparency to the distributor or the customer of the fairness of their distribution. No receiver of said resource knows how many resources were available and how they ended up receiving what they did. No distributor can easily quantify who is taking their less desired inventory when they could be taking the best. On top of that, if they feel the process was unjust, a customer has no way of easily quantifying the injustice. Nor do the distributors have a quantifiable way of judging how fair they distribute. There will always be highly valuable resources and low valued resources. Yet no process other than price rewards the choosing of high valued resources when they are needed and low valued resources when they are needed. No process rewards resource stewardship with more future choice.

### SUMMARY OF THE INVENTION

In one aspect of the invention, a computer-implemented system for allocation of a series of picks amongst multiple selectors in a selection process is disclosed. The system, comprises a processor and a non-volatile memory. The system is configured to receive input comprising number of picks, number of selectors, and number of picks per selector, store total picks data corresponding to the number of picks, number of selectors data corresponding to the number selectors, and picks per selector data corresponding to the number of picks per selector; using the total picks data, the number of selectors data, and the picks per selector data, to determine point values under a points system for allocating pick positions for each selector; for each selector, allocate picks according to the point system; and output a pick order. In one aspect of the invention, the system is further configured to use outside values in addition to the total picks data, the number of selectors data, and the picks per selector data to determine point values. In another aspect of the invention, the system is further configured to store, for each selector, points accumulated under the points system for use in further iterations of the selection process. In another aspect of the invention, the system is further configured to calculate, for each selector, a pick cost for awarding an overall pick to the selector, said pick cost relating to the pick and the point system; and award the overall pick to the selector whose total points when said pick cost is added most closely aligns with the point system; and repeat the calculation of the pick cost, and the awarding the overall pick to the selector whose total points when the pick cost is added most closely aligns with the point system, for every overall pick represented by the total picks data.

In another aspect of the invention, the pick cost is calculated by comparing the number of the overall pick to a benchmark pick which is calculated based on the total picks data, the number of selectors data, and the picks per selector data in accordance with a benchmark. In another aspect of the invention, the benchmark is to ensure that each participant would have the same average pick value. In another aspect of the invention, total points for an overall pick that most closely aligns with the point system is the lowest number of total points as compared to a plurality of alternative total numbers of points that would be awarded if the pick were awarded to a different participant.

In another aspect of the invention, the system is further configured to select a choice or choices on behalf of each selector in the order of picks awarded. In another aspect of the invention, the system is further configured to select such choice based on data corresponding to a ranking of available choices by each selector. In another aspect of the invention, the system is further configured to assign a choice value to each choice, and add the choice value of each selected choice to the total points. In another aspect of the invention, the choice is a work shift and the selectors are employees, such that the system is further configured to select a vacation choice on behalf of an employee wherein an employee may guarantee not to be allocated a particular shift, before the selection of shifts in accordance with order of picks awarded. In another aspect of the invention, the vacation is assigned a vacation value, and the system is further configured to use the vacation value along with the total points. In another aspect of the invention, the system is configured to select a choice or choices of vacation on behalf of each selector in order of picks awarded or prior points awarded by the point system.

In another aspect of the invention, a computer-implemented system for allocating resources amongst multiple selectors in a selection process, comprising a processor; and a non-volatile memory in communication with the processor is disclosed. The system is configured to: select a choice on behalf of each selector in an order; store data related to a value accorded to each choice eligible to be chosen; allocate points to a selector based upon the value accorded to the choice chosen by the selector; use the points in a calculation to determine a pick order in future iterations of the selection process; and output an allocation of resources amongst the selectors. In another aspect of the invention, the value is calculated based on a popularity of the choice in prior iterations of the selection process. In another aspect of the invention, the value is calculated based on previously entered preferences by the selectors prior to choices being selected. In another aspect of the invention, the system is further configured to allow the points can be traded between selectors. In another aspect of the invention, the value is based on external data.

In another aspect of the invention, the sum of the values of the available choices is zero. In another aspect of the invention, the system is further configured to select a choice on behalf of each selector based on a previously issued preference of the selector. In another aspect of the invention,the system is further configured to redo an overall pick in the event that the selector holding the subsequent pick has no ranked choices from which to choose. In another aspect of the invention, the choice is a work shift and wherein the selectors are employees, and the system is further configured to select a vacation choice on behalf of an employee wherein an employee may guarantee not to be allocated a particular shift, before the selection of shifts in accordance with order of picks awarded. In another aspect of the invention, the system is further configured to apply at least one rule to determine whether a vacation shift is feasible before awarding the vacation to the selector. In another aspect of the invention, the vacation is assigned a vacation value, and wherein said system is further configured to use the vacation value along with the points in future iterations of the selection process. In another aspect of the invention, the system is further configured to aggregate data related to the point system and at least one demographic factor relating to the selectors.

### BRIEF DESCRIPTION OF THE DRAWINGS

FIG. 1 is a view of a spreadsheet in accordance with an aspect of the present invention.

FIG. 2 is a view of a spreadsheet in accordance with an aspect of the present invention.

FIG. 3 is a view of a spreadsheet in accordance with an aspect of the present invention.

FIG. 4 is a view of a spreadsheet in accordance with an aspect of the present invention.

FIG. 5 is a view of a spreadsheet in accordance with an aspect of the present invention.

FIG. 6 is a view of a spreadsheet in accordance with an aspect of the present invention.

FIG. 7 is a view of a spreadsheet in accordance with an aspect of the present invention.

FIG. 8 is a view of a spreadsheet in accordance with an aspect of the present invention.

FIG. 9 is a view of a spreadsheet in accordance with an aspect of the present invention.

FIG. 10 is a view of a spreadsheet in accordance with an aspect of the present invention.

FIG. 11 is a view of a spreadsheet in accordance with an aspect of the present invention.

FIG. 12 is a view of a spreadsheet in accordance with an aspect of the present invention.

FIG. 13 is a view of a spreadsheet in accordance with an aspect of the present invention.

FIG. 14 is a view of a spreadsheet in accordance with an aspect of the present invention.

FIG. 15 is a view of a spreadsheet in accordance with an aspect of the present invention.

FIG. 16 is a view of a spreadsheet in accordance with an aspect of the present invention.

FIG. 17 is a view of a spreadsheet in accordance with an aspect of the present invention.

FIG. 18 is a view of a spreadsheet in accordance with an aspect of the present invention.

FIG. 19 is a view of a spreadsheet in accordance with an aspect of the present invention.

FIG. 20 is a view of a spreadsheet in accordance with an aspect of the present invention.

FIG. 21 is a view of a spreadsheet in accordance with an aspect of the present invention.

FIG. 22 is a view of a spreadsheet in accordance with an aspect of the present invention.

FIG. 23 is a view of a spreadsheet in accordance with an aspect of the present invention.

FIG. 24 is a view of a spreadsheet in accordance with an aspect of the present invention.

FIG. 25 is a view of a spreadsheet in accordance with an aspect of the present invention.

FIG. 26 is a view of a spreadsheet in accordance with an aspect of the present invention.

FIG. 27 is a view of a spreadsheet in accordance with an aspect of the present invention.

FIG. 28 is a view of a spreadsheet in accordance with an aspect of the present invention.

FIG. 29 is a view of a spreadsheet in accordance with an aspect of the present invention.

FIG. 30 is a view of a spreadsheet in accordance with an aspect of the present invention.

FIG. 31 is a view of a spreadsheet in accordance with an aspect of the present invention.

FIG. 32 is a view of a spreadsheet in accordance with an aspect of the present invention.

FIG. 33 is a view of a spreadsheet in accordance with an aspect of the present invention.

FIG. 34 is a view of a spreadsheet in accordance with an aspect of the present invention.

FIG. 35 is a view of a spreadsheet in accordance with an aspect of the present invention.

FIG. 36 is a view of a spreadsheet in accordance with an aspect of the present invention.

FIG. 37 is a view of a spreadsheet in accordance with an aspect of the present invention.

FIG. 38 is a view of a spreadsheet in accordance with an aspect of the present invention.

FIG. 39 is a view of a spreadsheet in accordance with an aspect of the present invention.

FIG. 40 is a view of a spreadsheet in accordance with an aspect of the present invention.

FIG. 41 is a flow diagram in accordance with an aspect of the present invention.

FIG. 42 is a flow diagram in accordance with an aspect of the present invention.

FIG. 43 is a view of a spreadsheet in accordance with an aspect of the present invention.

FIG. 44 is a view of a spreadsheet in accordance with an aspect of the present invention.

FIG. 45 is a view of a spreadsheet in accordance with an aspect of the present invention.

FIG. 46 is a view of a spreadsheet in accordance with an aspect of the present invention.

FIG. 47 is a view of a spreadsheet in accordance with an aspect of the present invention.

FIG. 48 is a view of a spreadsheet in accordance with an aspect of the present invention.

FIG. 49 is a view of a spreadsheet in accordance with an aspect of the present invention.

FIG. 50 is a view of a spreadsheet in accordance with an aspect of the present invention.

FIG. 51 is a view of a spreadsheet in accordance with an aspect of the present invention.

FIG. 52 is a view of a spreadsheet in accordance with an aspect of the present invention.

FIG. 53 is a view of a spreadsheet in accordance with an aspect of the present invention.

FIG. 54 is a view of a spreadsheet in accordance with an aspect of the present invention.

FIG. 55 is a diagram displaying a general purpose computer on which the system and method of the present disclosure may be implemented according to an aspect of the present disclosure.

### DETAILED DESCRIPTION OF THE INVENTION

Drafting

A draft is a process used to allocate certain players to sports teams in a league. In a draft, teams take turns selecting from a pool of eligible players. The players, or some subset of players, must subject themselves to the draft, and, if drafted, may only play in the league for the team that selected them. When a team selects a player, the team receives exclusive rights to sign that player to a contract, and no other team in the league may sign the player. To encourage parity, teams that do poorly in the previous season usually get to choose earlier in the postseason draft than those teams who fared better. A good example is the National Football League entry draft. It uses a reverse-record order. This is designed to self correct the league and keep all teams successful. Normally if a team wins the championship, they are given the last pick in every round of the upcoming draft. If they had the worst record, they are given the first pick in every round upcoming draft. The rest are ordered inversely to how they finished. Rounds are synonymous with the pick per team i.e. the 2nd round contains all second picks for every team involved. This way of ordering a draft is termed a fixed draft. All new players who wish to participate in the next season of play and were not on teams the previous season are available to be chosen. No players can be added to a team before or outside the draft, except for those players who declare their entrance into the draft and go undrafted. The bias of the draft is that the poorer teams the season before are given the earlier picks every round.

Inherent in the discussion and understanding of drafts is the terminology. For the purpose of this document, an “overall pick” is the position that a team is allowed to choose a player in the draft. If they are allowed to choose 48th, this is the 48th overall pick. In a league with 30 teams, the 48th overall pick is the 18th pick in the second round. A “team pick” is which selection is this for the team in this particular draft. Example: A team may have 5 team picks in a 50 overall pick draft. If they were evenly spaced they may have the 1st, 10th, 20th, 30th, and 40th overall picks, which would correspond to their 1st, 2nd, 3rd, 4th, and 5th team picks.

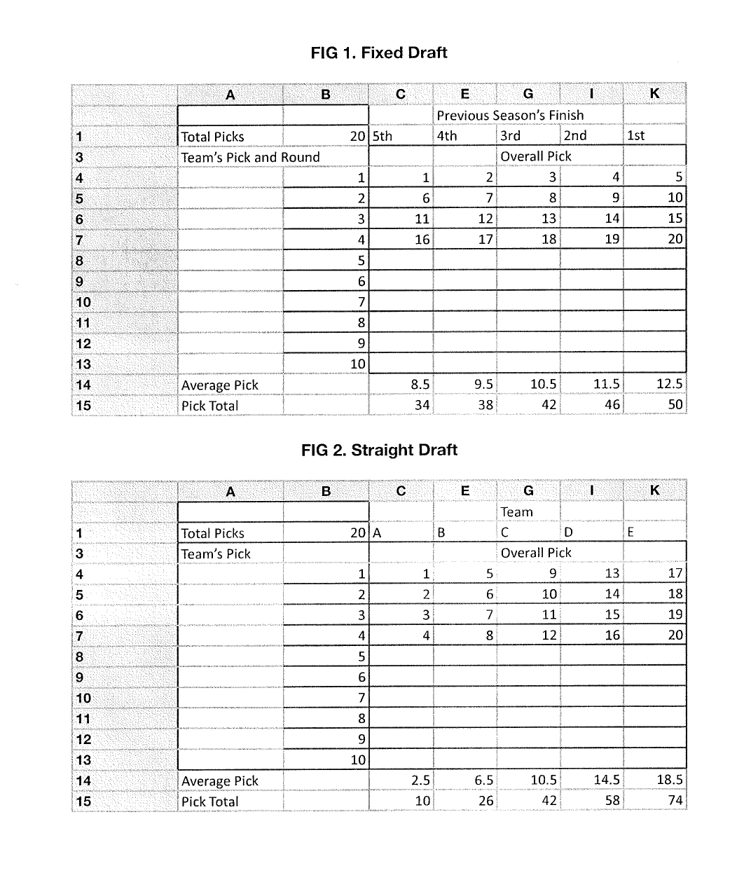

An embodiment of a five team, 20 pick, fixed draft, like that used in the National Football League, is illustrated in FIG. 1. In FIG. 1 the team that finished 5th (shown in column C) or last in this league is allowed to pick first in every round of the draft shown in column B. Overall picks in the draft are shown in C through K. The number of the round is synonymous with that team's numbered pick i.e. picks made in the second round are the second team picks for those teams. The 5th place or last place team (column C) is allowed to pick first in every round which corresponds with the 1st, 6th, 11th, and 16th overall picks in the draft. Those picks are shown in cells C4, C5, C6, and C7. While the 4th place team (column B) or second to last receives the 2nd, 7th, 12th, and 17th overall picks. In this aspect of the invention, each team's picks are listed out and averaged (row 14) of FIG. 1, to quantify the bias of the draft. This aspect demonstrates that the 5th place team picks 4 positions higher total than the person after them and averages 1 overall better position per pick (1+6+11+16=34; 2+7+12+17=38). The 4th place team has the same advantage over the 3rd, the 3rd over the 2nd, and the 2nd over the 1st.

Another type of draft is the straight draft. In this draft each team selects all their players at once i.e. they are given all their picks in secession. FIG. 2 shows the overall picks that Team A receives in Column C as the first four picks in the draft: 1, 2, 3, and 4. Team B in Column E receives the next four and so forth. The bias to this draft is quantified again in Row 14 and 15 which shows team A having 16 picks better than the next team and an average of 4 picks better per pick. Rounds have not meaning in this form of draft. The team pick corresponding to the overall picks in Columns C, G, E, I, K are shown in Column B. In this FIG. 2 each team averages 4 picks positions better than the team before and 16 total pick positions better seen again in rows 14 and 15.

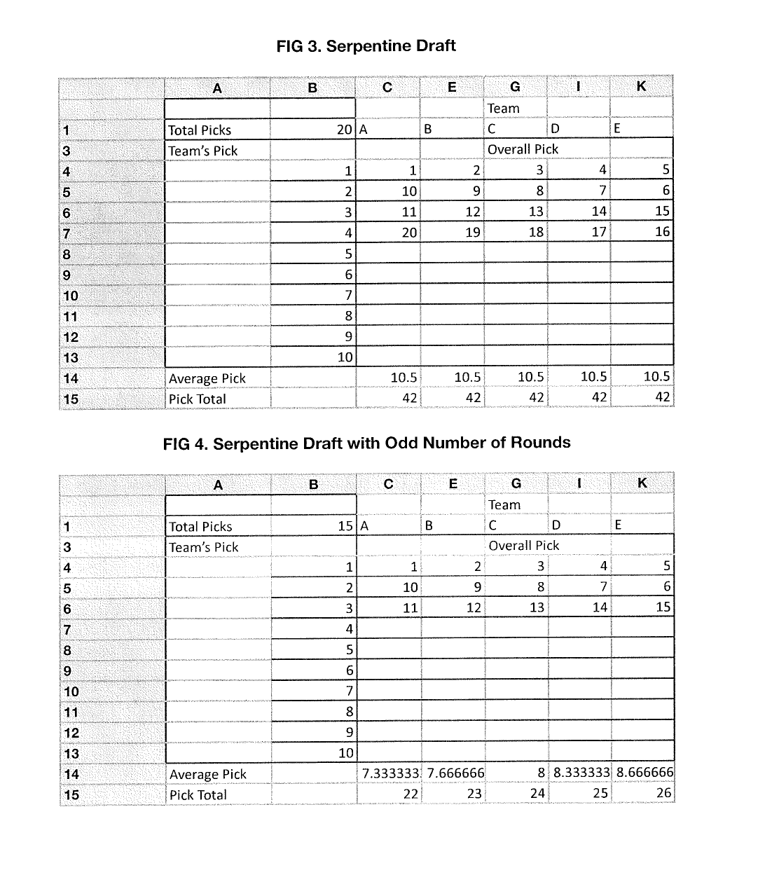

A commonly used draft in Fantasy Football leagues is the serpentine draft. In these leagues teams are created brand new every year and a one time fair draft is the priority instead of the self correcting mechanism and parity valued in the National Football League fixed draft. Serpentine drafts use rounds like a fixed draft, but do not keep the order of team picks consistent. In a serpentine draft the order of picks reverses after each round i.e. after every team has chosen their first pick of the draft (ending the first round), the order of picks reverses for the second pick (second round). In this manner the team to choose last for their first pick, chooses first for their second pick. In FIG. 3, once again overall picks are shown in Columns C, G, E, I and K, and team picks are shown in Column B. The fairness of this draft is displayed in rows 14 and 15 with identical average pick positions and identical overall pick position totals for each team in rows 14 and 15.

The serpentine draft is intuitively and numerically the fairest draft, but necessary to that fairness are two strict limitations.

Every team must have the same number of picks.

The number of picks per team (rounds) must be an even number.

If just one team has a different number of picks, or if the number picks per team is not an even number, a serpentine draft cannot be used. FIG. 4 illustrates a simple case where these requirements are not met. In this aspect five teams in a league have a choice of only 15 players (15 picks in the draft, 3 picks per team, 3 rounds). As can be seen by the average pick (row 14) and pick total (row 15), the once even serpentine draft of FIG. 3 is now biased by the removal of just one pick per team. Row 15 illustrates: Team A has a Pick Total one pick better than Team B, B has a Pick Total one pick better than Team C, C has a Pick Total one pick better than Team D, D has a Pick Total one pick better than Team E.

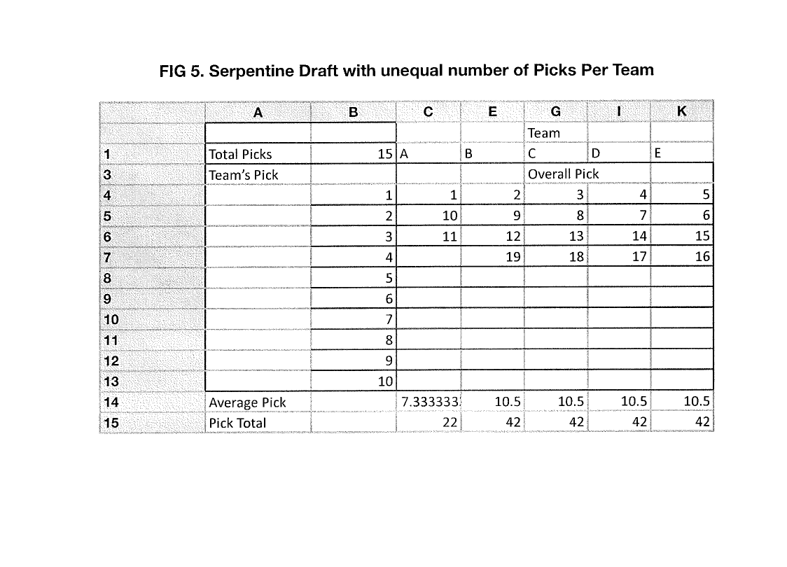

In another aspect, FIG. 5, the number of picks per team is not equal. Row 14 shows and an average pick which is 3.17 better per pick. How should this bias be rectified? Should the team with fewer picks draft first, third, skip a pick in the middle, at the end . . . ? All are difficult questions that only become insurmountably complicated when more than one team starts to have different numbers of picks.

Drafts are a powerful tool for distributing a resource transparently. The rules are the same for every team in a league. They know exactly how draft picks are ordered and all teams have equal opportunity for picks. Any team can have any player. Modern sports would not be the same without the fairness and parity drafts create. All teams know the rules to earning picks. The purpose of the invention is bring the concepts of drafting and its inherent transparent and fare process to other fields of resource allocation.

As they stand currently, the serpentine and fixed draft solutions impractical for real world applications. The fixed draft is too biased. And most resources don't have teams that want an “even” number of the “exact same number as everybody else” of their resource, so a serpentine draft is out.

In order to create a more versatile solution, the serpentine draft was first examined. In the draft illustrated in FIG. 3, every team's picks has symmetry around the average of 10.5. Team A picked 1st so they had to pick 20th to balance. When 10.5 is subtracted from both picks the result is −9.5 and 9.5. The 2nd (10) and 3rd (11) pick of Team A are even more obviously symmetric around 10.5. When 10.5 is subtracted from them, −0.5 and 0.5 result. When those symmetric picks are subtracted from each other the result is zero. Now every number has its counterpart that is equidistant from 10.5 or any other number. To standardize a draft process, a standard for the best set of symmetric numbers was needed. Equally spaced symmetric numbers are the most fair. From this general idea, the Ideal Picks Equation was defined. The Ideal Picks Equation takes any number of team picks, in a draft of any number of overall picks, and spaces them out evenly and symmetrically around the average pick of a draft. The average pick of a draft is defined as

(Total Overall Picks+1)/2

One might assume that Total Overall Picks/2 would be correct, but simple examples show otherwise. The center of 3 is 2 (there is one choice on either side of 2 i.e. 1 or 3). The center of 5 is 3 (1 and 2 on one side and 4 and 5 on the other).

With this in mind the Ideal Picks Equation was derived that defined symmetric and equal spaced picks for any number of team picks for an number of overall picks. It is dependent on three variables:
Team Total Picks—how many picks a team has in a draft
Overall Picks—how many picks are there in the entire draft
Team Pick—what pick is this for that specific team
   It meets the following conformities:
1. Total Team Picks and Team Pick=1, Ideal Pick=(Draft Picks+1)/2
2. When Total Team Picks=Draft Picks, Team Pick=1, Ideal Pick=1

Ideal Pick=(Draft Picks)/(2*Team Total Picks)+1/2+(Team Pick−1)*(Draft Picks/Team Total Picks)

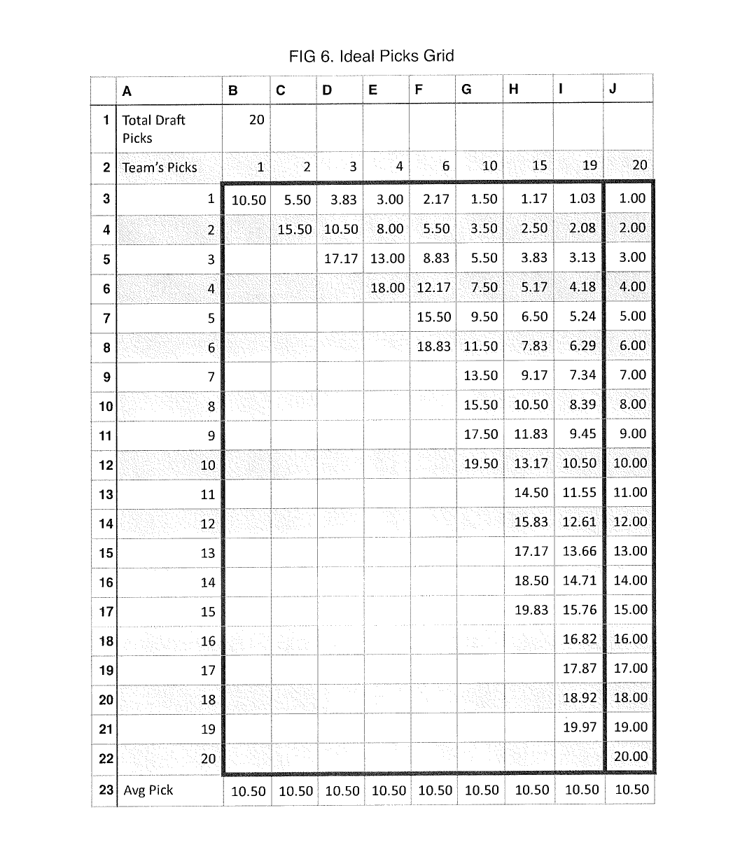

FIG. 6 illustrates this equation applied to a draft with 20 picks. Teams with different numbers of picks in the draft are displayed (row 2). Their subsequent ideal picks are listed in columns B through I. 10.5 is the center of all picks and the average of all ideal picks for any number of possible picks in this draft, as shown in row 23. All picks are equidistant from the average pick (in this case 10.5) and evenly spaced. All odd number Team Picks include the Average pick.

Also it can be seen that “Draft Picks/(2*Team Total Picks)+1/2” converges at 1 as Total Team Picks approaches Draft Picks. This assures that the 1st pick in any draft should always be most proximal to the 1st Ideal Pick of the team with the most picks in the draft. The second term “(Team Pick−1)*(Draft Picks/Team Total Picks)” goes to Team Pick−1 as Team Total Picks nears Draft Picks. At this point the last pick will near Draft Picks and “Team Pick−1” will near Draft Picks−1. At the same time the first term has neared 1, so 1+Draft Picks−1 nears Draft Picks. As the first term is nearing 1, the last pick will near Draft Picks (the last pick in the draft). This mirrors what is expected as the team with the most players to choose will have the first and last picks. Following the first and last picks in the Ideal Picks Grid for the teams with increasing picks from left to right: 1, 2, 3, 4, 6, 10, 15, 19, 20 with corresponding first and last picks of 10.50/10.50, 5.50/15.50, 3.83/17.17, 3.00/18.00, 2.17/18.83, 1.50/19.50, 1.17/19.83, 1.03/19.97, 1.00/20.00.

The Ideal Picks Equation states there is one set of ideal picks for any team in any draft. It also means that if two teams in the same draft have the same number of picks, they cannot both have the same picks. Therefore they cannot both have their ideal picks. This issue comes up frequently. What also is evident is that the Ideal Picks are many times fractions, yet picks are whole numbers. So how is this equation useful if rarely even one team in a draft can have these picks, and never can two? It establishes a point system for pick position in a draft. Picks can be arranged and that arrangement can be quantitatively ranked or scored against that points system. With a point system, other variables in the system can be converted to that point system and used to manipulate pick positions. With a point system, pick position can be optimized with a goal. This aspect of the invention uses a point system of ideal picks. Centered around the average pick. Whose picks gradually near every pick in the draft as the team's picks near the total picks in the draft. The overall purpose of this point system being to give every player the same average pick no matter how many picks they have in a draft. Other point systems are possible and one skilled in the art can imagine ranks, ratios, or other formulas that accomplish the task of a point system for pick position.

The value PickCost is defined as the difference between a pick and its corresponding team's ideal pick. Therefore, when a team's pick is before its ideal pick, it loses points (PickCost is negative). When a team's pick is after it's ideal pick, it gains points (PickCost is Positive).

Pick Cost=Pick−(Ideal Pick)

Pick Cost=Pick-Draft Picks/Team Total Picks/2+(Team Pick−1)*(Draft Picks/Team Total Picks)−1/2

As has been previously stated, there is only one set of ideal picks defined by the Ideal Picks Equation for each combination of Team Total Picks and Draft Picks. Therefore, if more than one team in a draft has the same amount of picks, there are not enough ideal picks to go around. As will be seen, the Pick Selection process utilizes the point system established by PickCost to account for this and balance drafts picks in later picks.

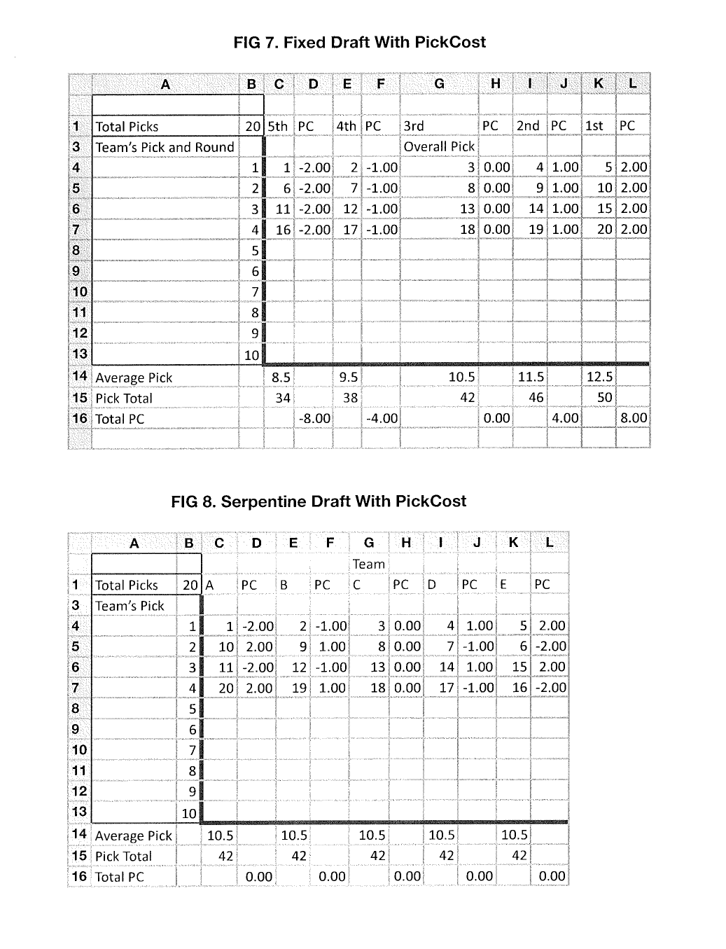

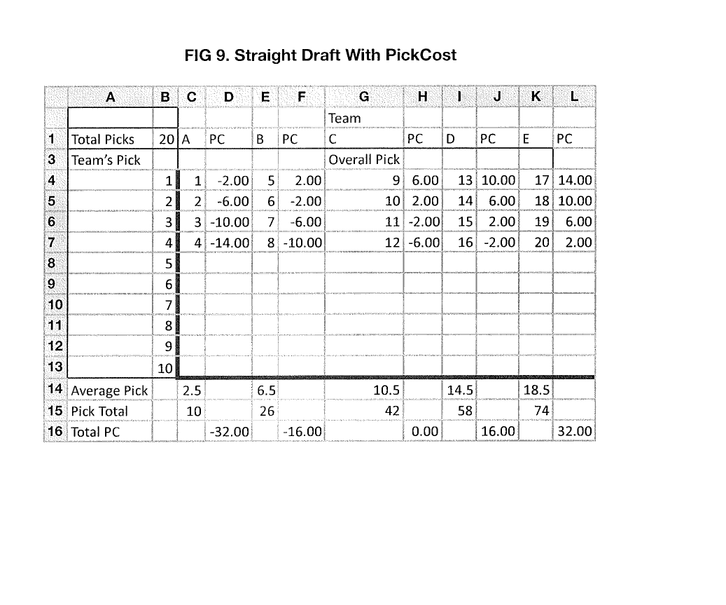

To start with, lets reveal the PickCost calculations for our previous draft examples and quantitatively score them with our point system. FIG. 1's PickCosts are shown in FIG. 7. Columns D, F, H, J, L show PickCost calculations for each of the columns proceedings picks i.e. cell D4 is the PickCost for C4. The totals are at the bottom in row 16. They represent the picks from ideal each team has. The team with the ideal picks is the 3rd place team in column G. In column H, the 3rd place teams PickCosts are all zero as they are all ideal. The fifth place team's picks are all −2 (Column D) meaning they are all 2 pick positions before their corresponding ideal picks.

FIG. 8 illustrates the scoring of FIG. 3 with PickCosts. Notice that all PickCosts zero out when totaled, but only one team has all ideal picks for a team with 5 picks in a 20 pick draft. That is Team C in column G. All other teams have balancing or symmetric picks, therefore they all have PickCost totals that equal zero and equal average picks.

PickCost can do more than just score already predetermined picks positions. Through one aspect of the invention, The Pick Selection Process, PickCost is used to order the pick positions themselves for a draft. PickCost can score each pick position for each player individually. PickCosts can also be added to give an overall score for the team. Therefore in a draft of any number of teams with any number of picks, PickCost can be utilized to create the fairest draft mathematically possible. With many combinations of teams, picks per team, and total overall picks, completely fair drafts are not possible. But with a scoring system like PickCosts, those drafts are ordered as fairly as mathematically possible and what is unfair about them is quantified.

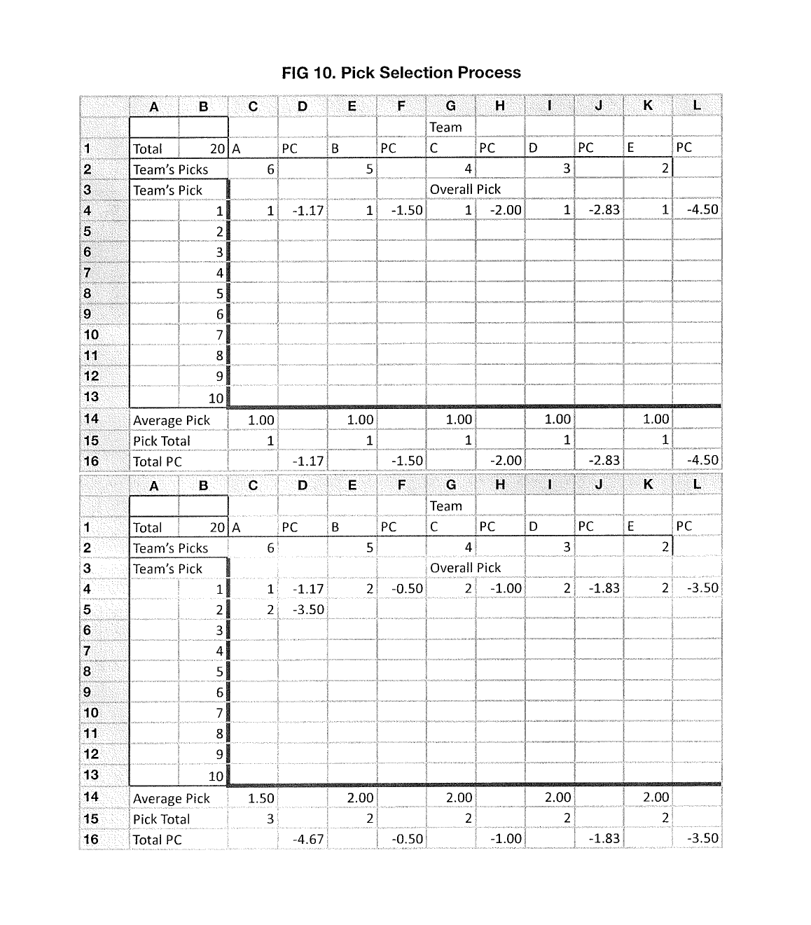

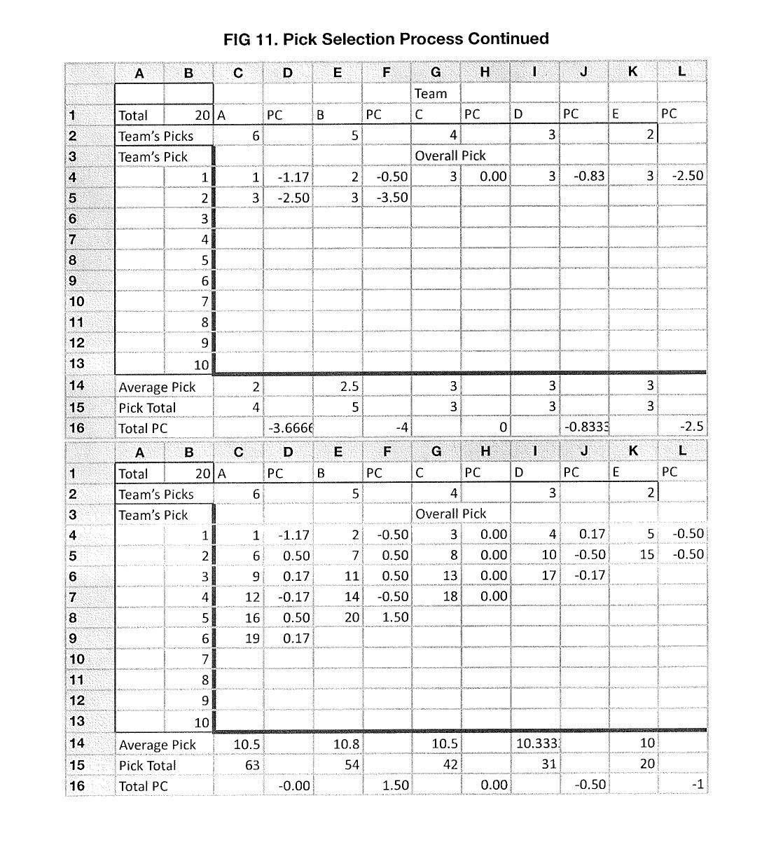

FIGS. 10 and 11 illustrate the use of PickCost to distribute picks in a draft. To illustrate the flexibility of The Pick Selection Process teams with markedly different numbers of picks are used. The picks per team are shown in row 2 (6, 5, 4, 3, 2). The picks are distributed to minimize the deviation from the Ideal Picks for each team. Put another way the picks are position to minimize the total of all PickCosts calculated for all picks.

The process begins by calculating the PickCost for each team for the first overall pick. The team with the PickCost closest to zero, has its ideal pick for its first pick closest to the first pick. In this case Team A with −1.17. Therefore the pick is granted to Team A. When a pick is granted, the PickCost associated with that pick is added to the winning team's Total PickCost (Row 16). The second overall picks PickCost is then calculated for every team. This time Team A, already has a PickCost Total from its first pick. The PickCost Total is compared, and the team again with the PickCost closest to zero is granted the pick. In this case it is Team B in Column E. The PickCost associated with that pick for that team is added to that teams PickCost total and the process moves on to the next pick. By the end of the Pick Selection Process the bias of the draft is displayed by the PickCost totals. Team B has gained points (1.50 in cell F16) and Teams D and E have lost points (−0.50 and −1 in cells J16 and L16). In this case a completely fair draft (one where all PickCost Totals zero out) is impossible, but the use of the point system PickCost has captured and quantified the inequality. This draft was not completely fair, but now that the system has quantified the bias, it can use it in subsequent drafts to equal things out.

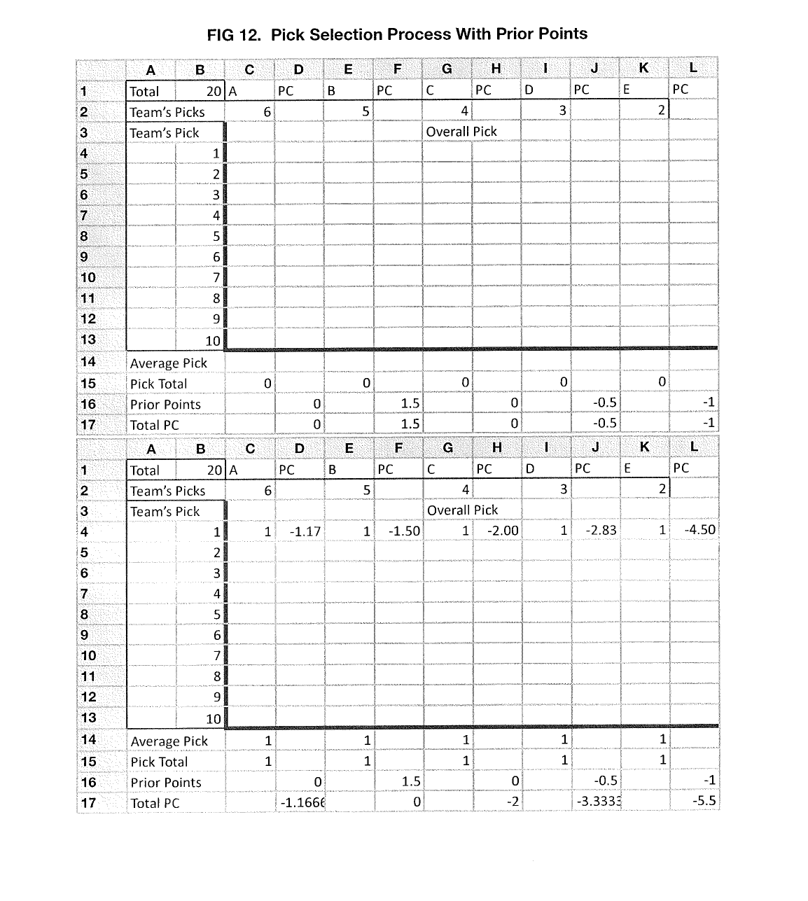

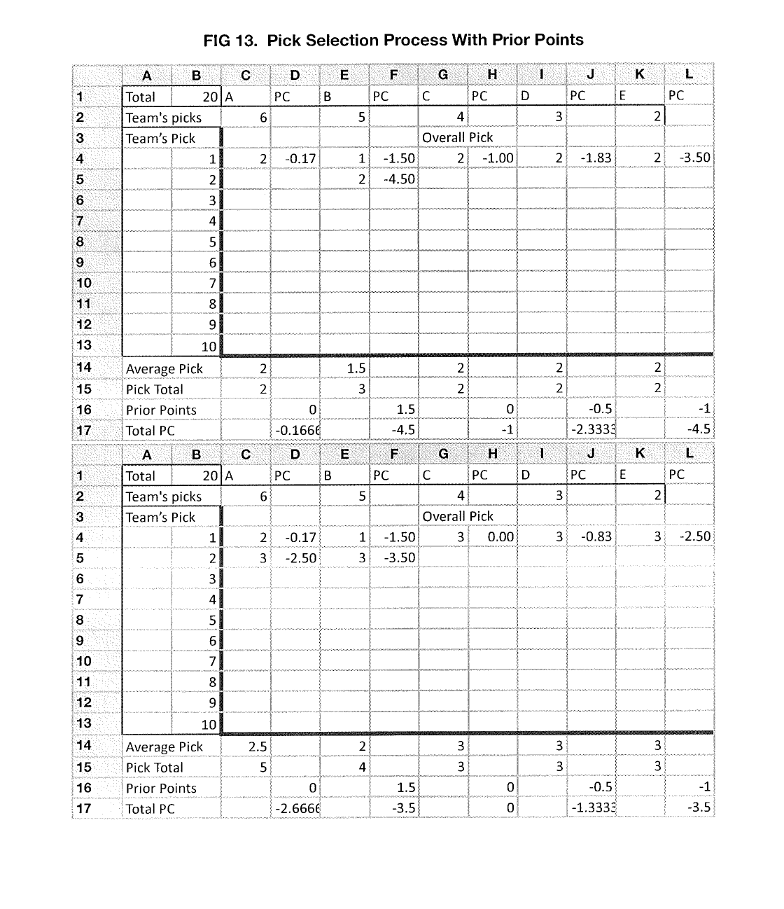

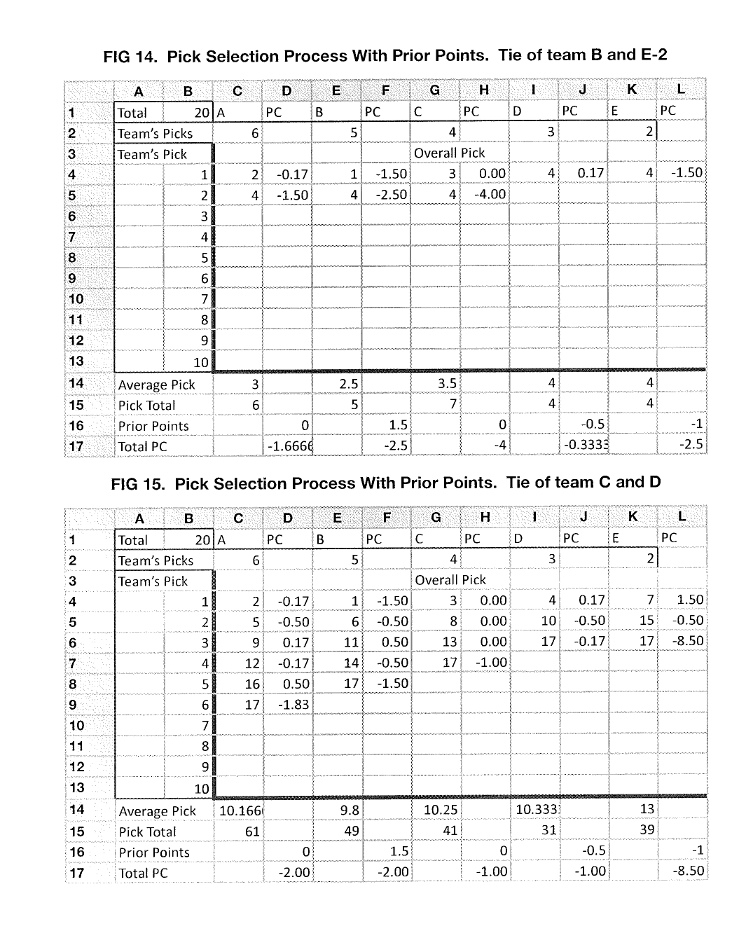

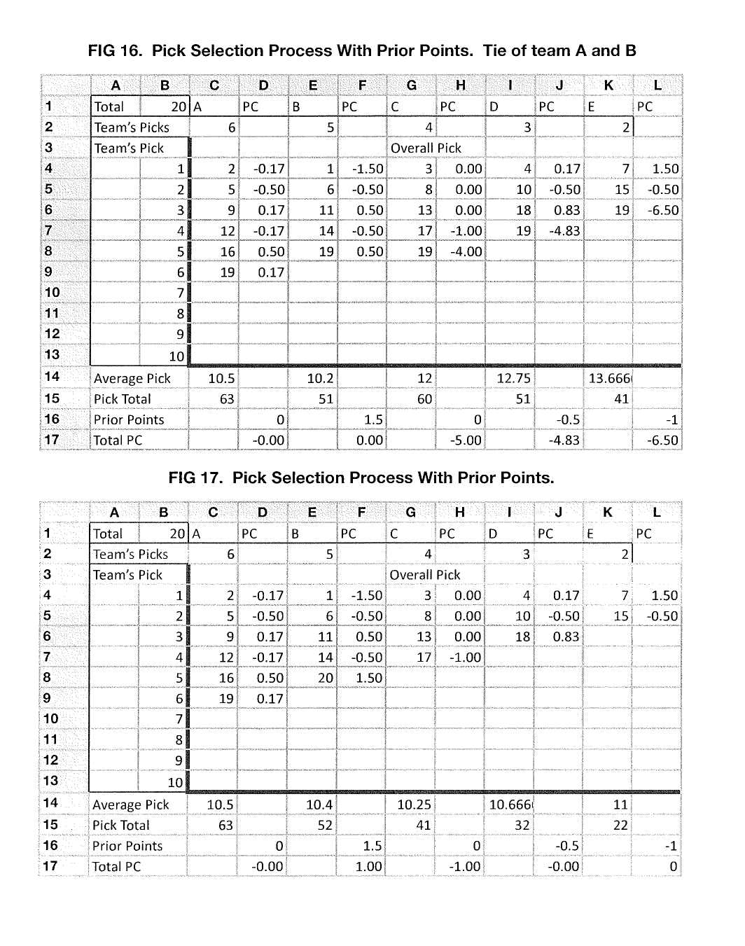

FIGS. 12-17 shows how in a subsequent draft, the inequalities of FIGS. 10 and 11 are balanced. In this aspect Total Pickcost (row 16) of FIGS. 10 and 11 is added to a new row 16 as Prior Points of FIGS. 12-17. As this new Pick Selection Process proceeds the bias of the previous Pick Selection Process is balanced by adding the Prior PickCosts to each Team's totals before the start of the process. The addition of these Prior Points moves Team A from 1 and 6 to 2 and 5, Team B from 2 and 7 to 1 and 6, Team C from 18 to 17, Team D from 17 to 18, Team E from 5 to 7.

Ties will occur in the Pick Selection Process. Ties occur when it works out that one team's Total PickCost would be identical to another's if they both were to receive the same overall pick at the same time in the Pick Selection Process. These ties are inevitable in the invention and give an opportunity to reward teams by a secondary means other than just prior points and PickCost. Common secondary tiebreakers include seniority (the longer a team has been with that draft)and volume of work (how many picks that team makes in the draft), but anything else a draft would prefer can be used as a secondary tiebreaker. For simplicity in this hypothetical draft the secondary value used for a tiebreaker is alphabetical order i.e. A, B, C, D, and finally E.

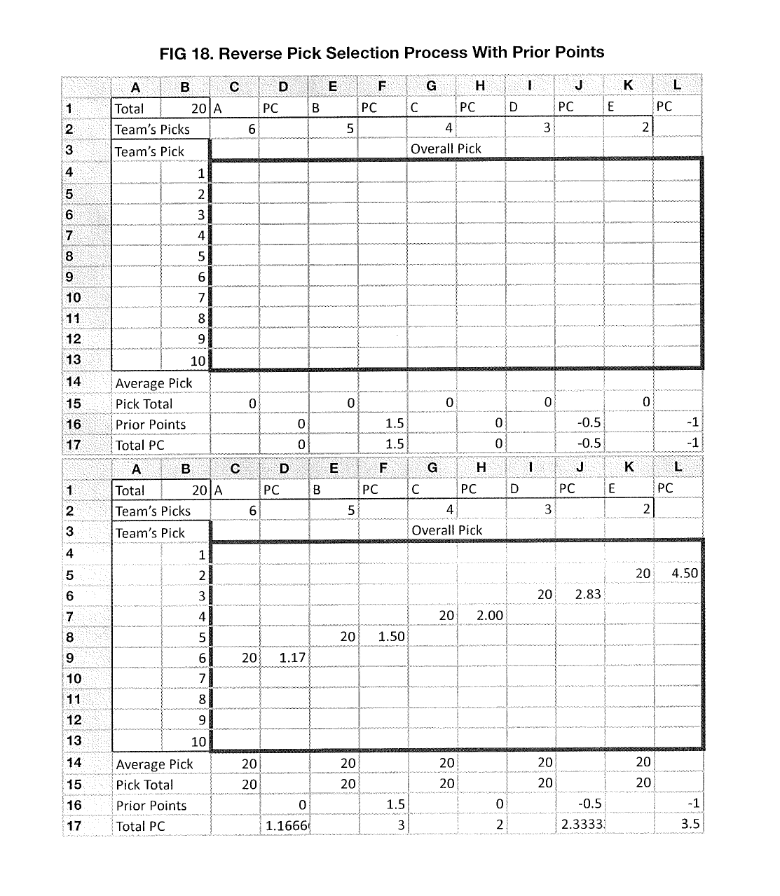

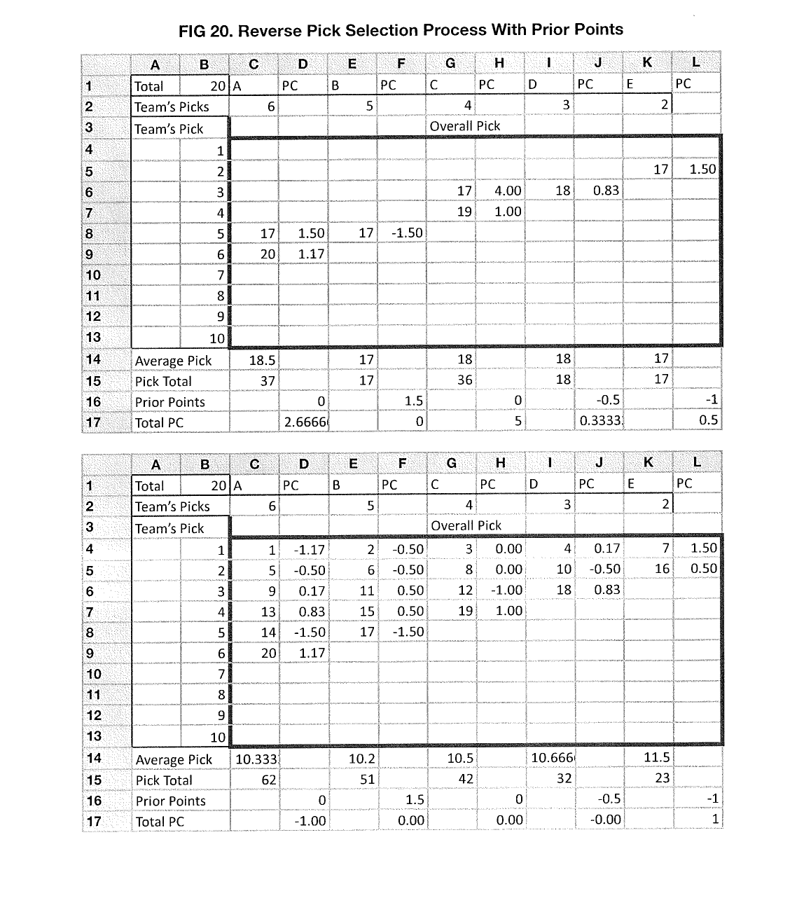

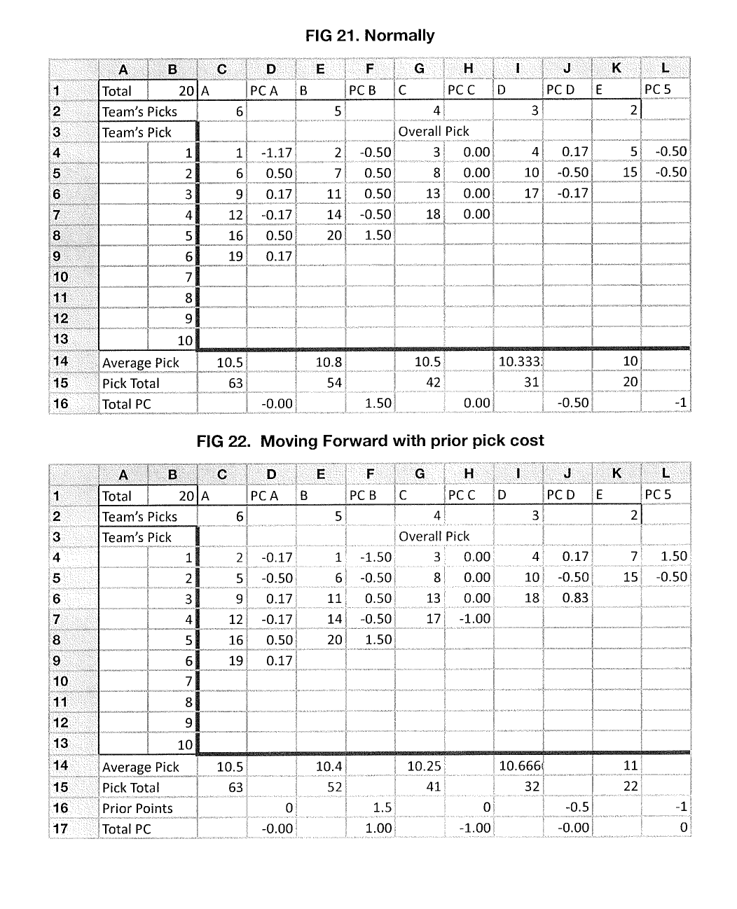

In this aspect, Prior Points affect the earlier aspect of the Pick Selection Process more than the end i.e. they affect the first picks assessed more than the last. Therefore in drafts which value avoiding the last picks in a draft versus picking as early as possible, the Pick Selection Process begins by assessing who should receive the last pick in the work selection process. In an aspect where the first picks are more desired (as previously described), the process starts with the first pick and moves forward, thereby granting the first picks to those with the most points. In an aspect for selecting tickets it would start with the first pick, this would give those with the most points, the first pick of the best tickets. In another aspect, where participants are selecting days of the week to work, the process would likely work best last to first. In that situation workers are more concerned with avoiding working the worst shifts (i.e. weekends) then they are picking the best of the Monday shifts. Either Pick Selection Process has its merits and is utilized depending on the wants of the system and its users. Another aspect has the process starting at the middle of the draft and working out symmetrically. Another has the process starting at 20% in from the last pick of the draft. Any start position is possible and any method of working through the other picks is possible. Depending on the desired affect of the system. Another aspect has a participants Prior Points evenly distributed in order to move each pick a small fraction instead of the previous methods which move the starting picks the most respectively. This aspect values the incremental change in each pick more than just moving a few greatly. FIGS. 18-20 illustrates the difference in going forward or reverse. As in this process, Worker B's last pick moves from 20 to 17. As compared to FIG. 21 which is the normal forward process without Prior Points, and FIG. 22 which moves the first pick from 2 to 1 compared to FIG. 21. The direction the Pick Selection Process takes is irrelevant if Prior Points are not incorporated, but as was illustrated, alters pick positions earlier in the process more than late.

The point system established here by the PickCost equation and the Pick Selection Process heretofore demonstrated allow this aspect of the invention to balance any number of teams with any number of team picks of any number of total picks as fairly as mathematically possible. It also can be used to capture the bias of any possible combination of picks for any combination of teams that either it has ordered through the Pick Selection Process or not. As shown it is easily implemented on paper or in any modern spreadsheet application.

With the help of a modern computer, thousands and thousands of variations can be balanced in seconds. This aspect also allows for the quantification of inequalities. Those quantified inequalities can be used in any way the system desires. They are demonstrated here skewing subsequent pick selection processes in order to perpetually balance a system.

Player Valuation

Professional athletes gain a large amount of respect from when they are taken in the draft. The first pick of the draft is normally thrust into the spotlight with high expectations and high salaries. The subsequent players have proportional accolades and salaries according to their draft spots. In the standard sports drafts where the number of picks doesn't change from year to year, people in the industry become accustomed to the relative value of picks. They know what a player taken in the first round is worth versus one in the second round, because these rounds are always the same size. But what if the number of picks changed every year? What if one year the first round doubled in size? All the sudden the value of being taken in the middle of the first round is not as obvious. In many real world situations this is exactly the case. Rounds change in size. Drafts change in size. These things need to be dynamic to suit their systems. Unfortunately in those occasions, valuing the player chosen even relatively is much more difficult.

Where a player is taken in a draft gives insight into his worth. An aspect of the invention uses a fraction to communicate this. If a player is taken 10 of 20, the numerical ranking is 1/2 in an aspect of the invention. In another it is the reciprocal, two. The ranking would be the same in both aspects if the player were taken 20/40 or 1/2.

The above described process of drafting is complete when balancing picks is all that is desired. If a draft was unfair on one occasion the PickCosts can be carried over as Prior Points and balance the next one. The point system could balance the picks in the system for perpetuity. Could even more be procured from the process? Could other variables in the system be converted into the point system? Could the system use those outside points to influence change? What if the value of players could be obtained? What if pick position could be altered according to points obtained outside the draft? What if resource stewardship could be rewarded with higher pick position? Then the system would challenge its teams to examine every player they choose. Teams could choose to pass over popular players in order to choose who they really need and be rewarded for doing so. This could set up a draft that more justly distributes talent and penalizes stockpiling or siloing talent on teams without need. This could set up a draft that is ordered according to any incremental change in any point system.

The National Football League Entry draft currently orders picks according to the finish of the teams the year before. No account is made for how much worse one team may have been versus another. The last team may not have won a game, while the second to last may have won 5 games. Yet in the current draft, the last place team picks first and the second to last picks second. If instead of if by finish, points were assigned by games won, the last place team may receive two picks before the first place team received one. In some systems that may be desirable. With the use of a point system like the Ideal Picks Equation and Pick Selection Process, any other variable, task, accomplishment, or asset can be awarded points that relate to that system. Those points can then be used to position picks in the upcoming draft. Other point systems could be reliant on how many points a team scored the year before or maybe attendance at home games. In a different aspect that looks to influence sales in an electronic store, points are based on how many speakers an employee sells.

In another aspect of the invention, the point system is based on the demand for the players being drafted. Rank Values are derived in a separate process outside of the draft. These values are then used to value the players picked by a team. With These valuations, the system can reward or punish teams for their resource stewardship i.e. taking only what they need. For example if a team passes on a highly valued player for a lower valued player, they could receive points to apply to their Prior Points of an upcoming draft. Thereby passing on a player they don't need for higher picks in the next draft. Aspects of the invention use pre ranking, overall demand, expert opinion, database manipulation, previous or parallel draft experience, scheduler preference, and all manner of combinations to value players and relate them to the point system. This external mechanism of valuing players allows the system to position picks by means other than Prior PickCost. In an aspect of the invention, the sum of a teams Rank Values are added to the Prior Points in the Pick Selection Process instead of Prior Total PickCost. In this aspect, whom a team picks and not when they pick determines their pick's positions in the next draft. In this aspect teams weigh not only the most valuable player in the draft when they make a selection, but what is most valuable to them. Because if they pick a player who is highly valued, it costs them position in the next draft. When they select a player which no one else wants but them, they will likely gain points and be rewarded with a higher position in the upcoming draft.

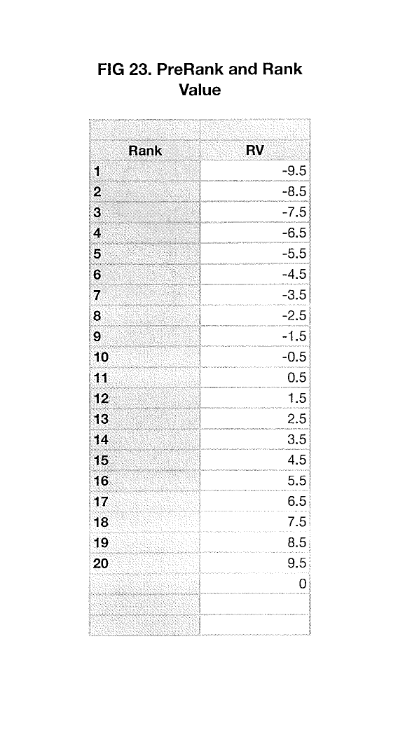

In one aspect, teams participating in the draft pre rank every player in the upcoming draft. In order to encourage honesty in ranking, the rank lists are used solely to choose players in the draft and there is no live participation in the draft by the teams. FIG. 23 illustrates hypothetical average ranks for 20 players in one of this aspect's drafts. In this aspect those ranks are converted into other values centered around zero, named Ranked Values (as the initial information is a rank list). In other aspects this is not the case, but for the purpose of this aspect, the points are easier to manage if they are centered. The centered Rank Value (RV) that corresponds to each rank is listed in column RV. The zero valued player is the player ranked in the middle of all players.

The center of a sequential list of choices like picks of a draft or player rankings is

(Number of Choices+1)/2.

When the center of a group of sequential rankings is subtracted from the individual ranks, they are recentered around zero. Thus:

Rank Value Median=RV med=Median Rank−(Number of Ranks+1)/2

Rank Value Average=RV avg=Average Rank−(Number of Players+1)/2

In this aspect it is seen that Rank Value is symmetric around zero and sums to zero if the ranks are sequential and equally spaced. This is desired in systems where teams may come and go. This way new teams can always start at zero and not be penalized by the years and years of points that may have already been built up. In another aspect, new teams enter with the average number of points in the system.

Rank Value and PickCost as they are defined are both centered around zero.

When

Last Rank=Draft Picks,

(Last Rank+1)/2=(Draft Picks+1)/2

Like PickCost, Rank Value begins with the premise of symmetry around the middle pick of a draft. Like PickCost has Ideal Picks, Rank Value's “Ideal Player” is the middle ranked player. If a team receives players valued before the middle pick, they lose points. If they receive players valued after the middle, they gain points. The middle pick in a draft is worth zero points. In the system so defined, all Rank Values sum to zero. No positive points can be created without negative points being created. A draft with perfectly symmetrical picks where every team picks the highest valued player with every pick will have zero points exchanged between its teams. If a team decides to draft lower pre ranked players, then they will gain points. In an aspect of the invention those points are used in subsequent drafts for better picks. In this aspect the scale is linear. In another it is factorial. In another exponential. In another the function is a step function. All mathematical varieties are possible depending on the desired effects and how the system feels its particular player's values relate from one pick to another. In another aspect the system is asymmetric and allows the total Rank Value to rise or diminish. The point system here shown is for example and anyone skilled in the art can devise a point system of their own that suits the purpose of scoring a variable in a system in a relateable fashion to a scoring system for positioning picks in a draft.

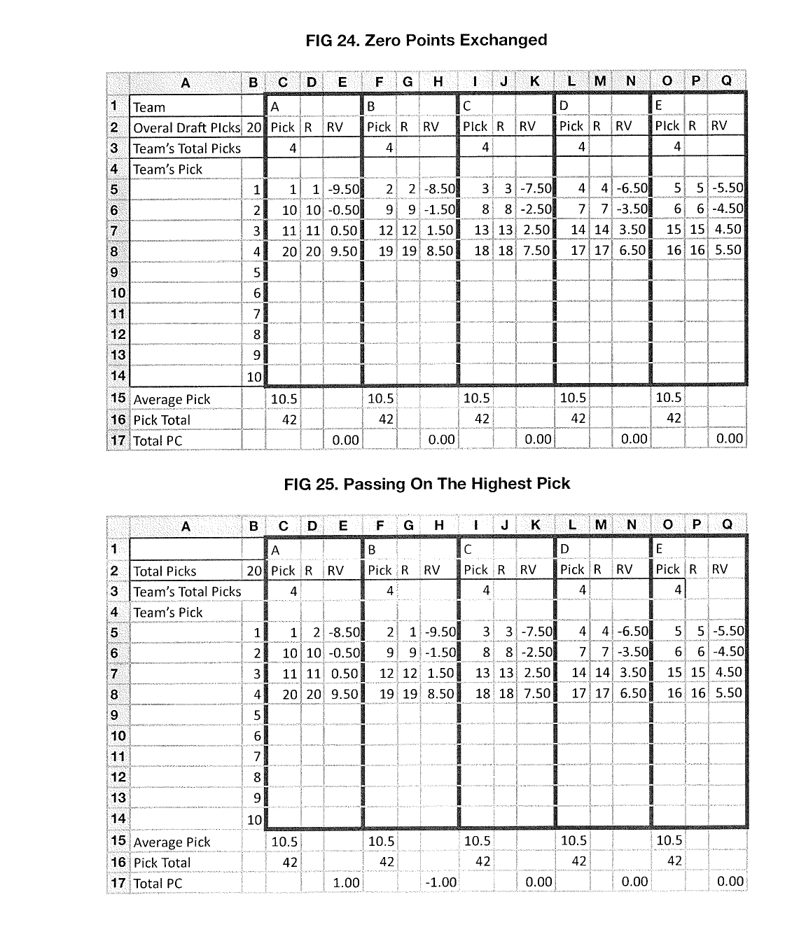

FIG. 24 shows a 5 team, 4 pick per team, draft of 20 players. The columns headed with Player R, show the player ranks for the player chosen by the team at the pick position in the column before. Example: The first pick of the draft (C4) was the 1st ranked (D4) player in the draft worth −9.5 points (E4). Columns headed Player V show the valuations corresponding to those rankings using the Rank Value equation. FIG. 24 has zero points exchanged between teams as all teams chose the highest ranked available players with their picks. FIG. 25 demonstrates Team A passing on the highest ranked player for the second highest ranked with the first overall pick in the draft. The second highest ranked player is only worth −8.5 (E5) versus the highest ranked player of −9.5. All other things being equal Team A gains 1 point. Meanwhile Team B who took the highest player as the second choice in the draft and lost 1 point (E17), which can be carried over to the next Prior Points of the next Pick Selection Process. This aspect of the invention encourages team preference in selection to the betterment of the system i.e. a team that needs a running back and already has a quarterback chooses the best available running back instead of a higher ranked quarterback and is rewarded with higher pick positions in the next draft.

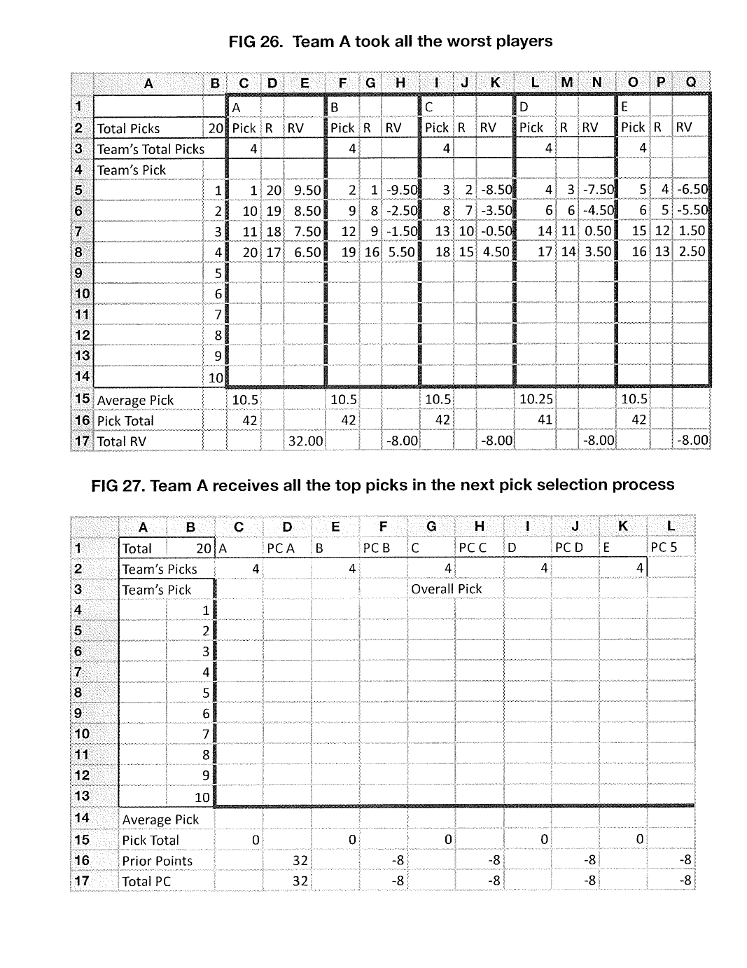

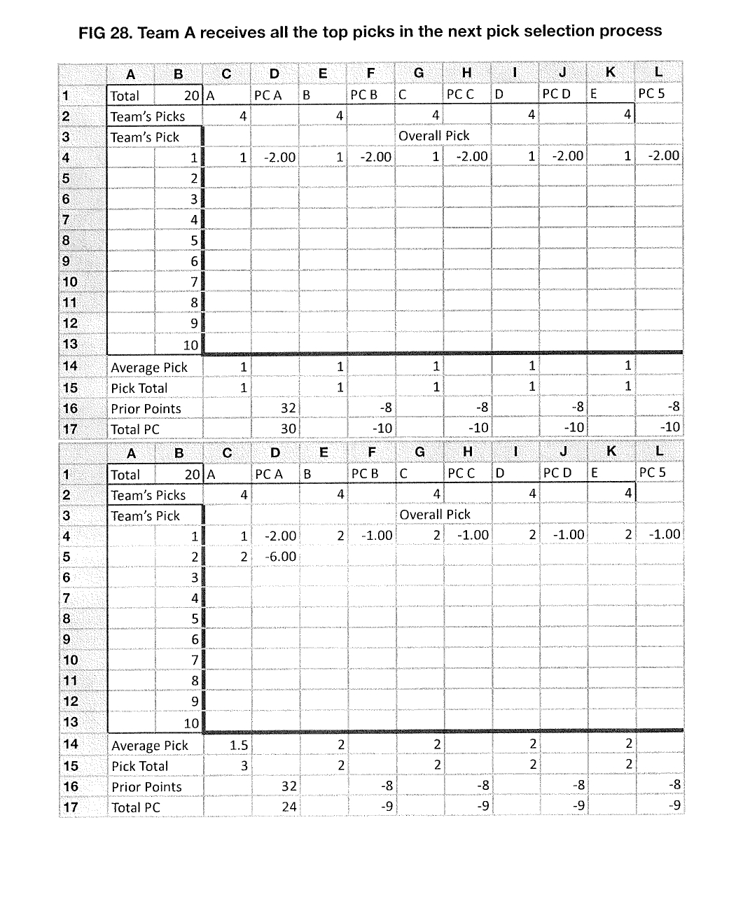

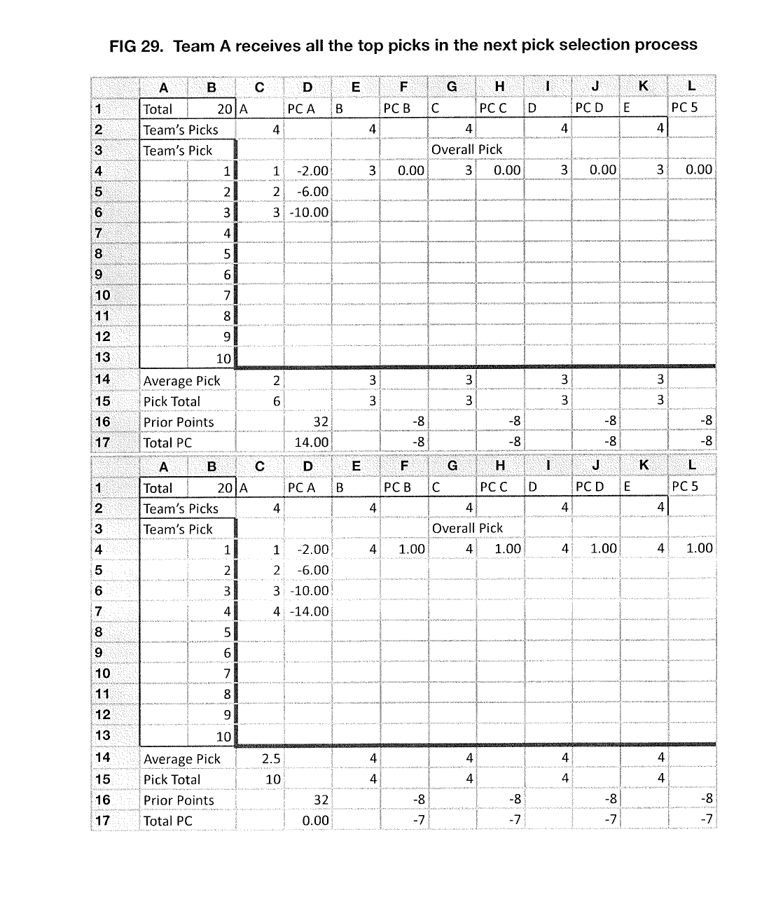

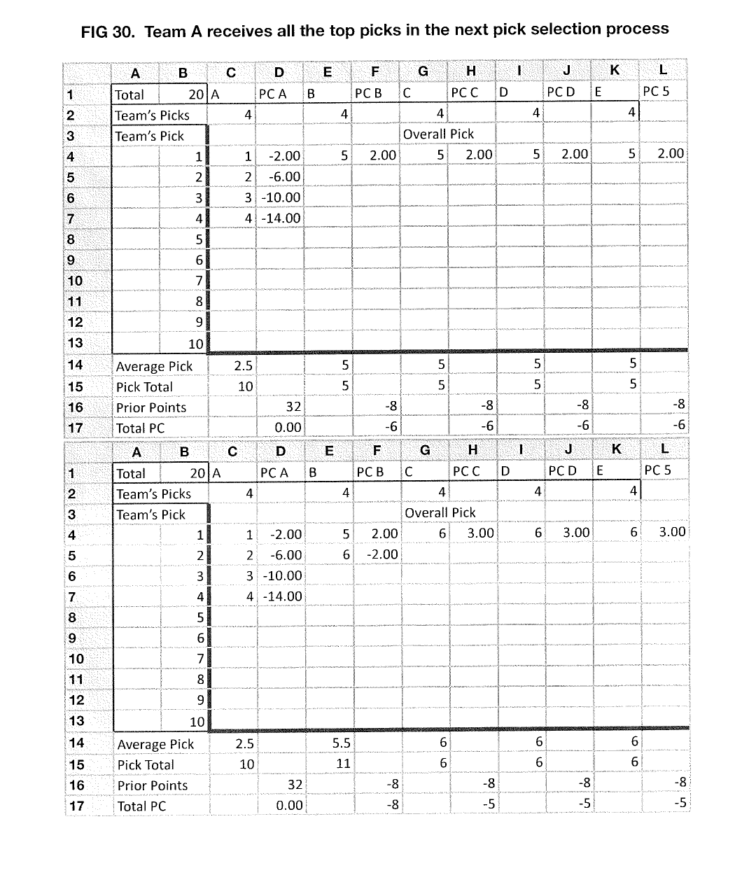

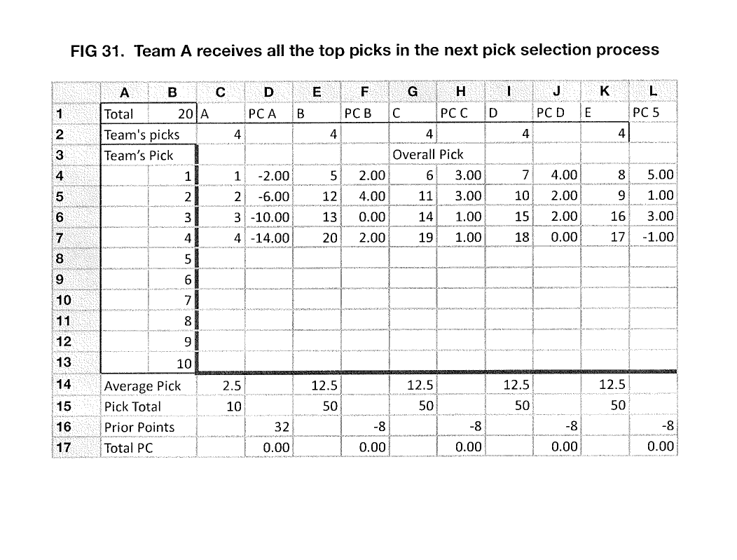

Further illustration of the interplay of Rank Value and the Pick Selection Process is shown by FIG. 26. Looking at Team A's Player Ranks They are 20, 19, 18, and 17 with their corresponding Rank Values. When the Players Total Values are applied to the Prior Points (row 16 of Team A receives all the top picks in the next pick selection process (FIGS. 27-31)) of the next Pick Selection Process, Team A receives all the best picks in the next Pick Selection Process (FIGS. 27-31), column C with Team A's picks of 1, 2, 3, 4. The point system here established by the interplay of PickCost and Ranked Value dictate this pick position. One skilled in the art, could easily devise different point systems that dictate the same or that dictate other desired pick positions depending on the points gained through player selection or any other variable point system. Circling back to the National Football League comparison, one could see an advantage to giving a perennially horrible team all the first picks in the next draft in an attempt to bring them out of the doldrums. The point system that would accomplish that would be inversely proportional to losses per year and have a multiplier or doubling effect for every year that a team is in last place.

In other aspects of the invention, demand for a player is measured not by ranking the player but by percentages of overall demand. The ratio of demand is then turned into a points system, that contributes to Prior Points in the Pick Selection Process and skews pick position.

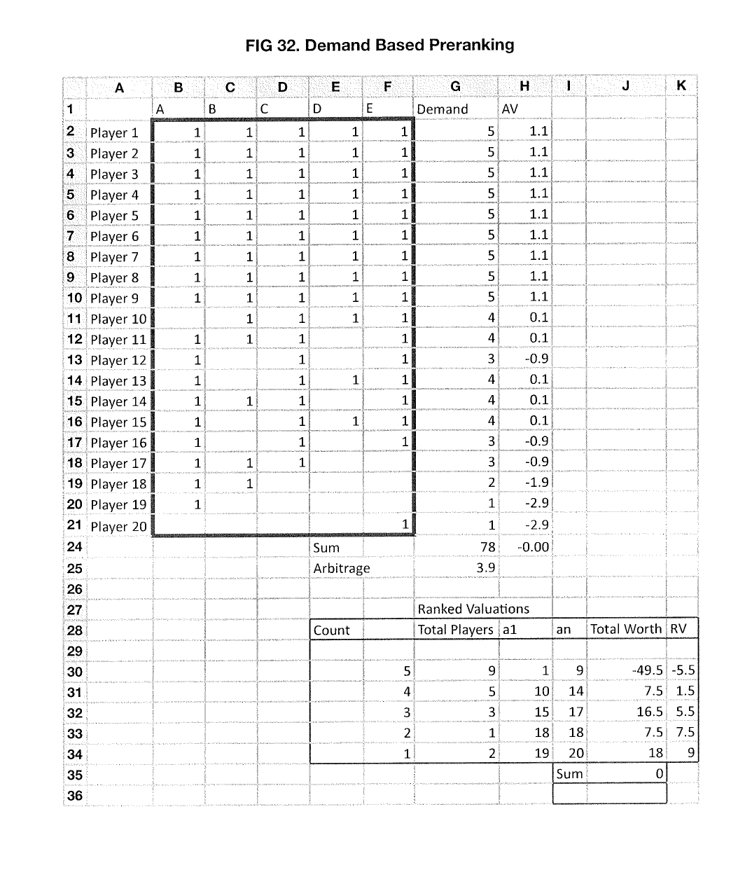

FIG. 32 has 20 players with all five teams requesting them to varying degrees. A request is signified with a “1.” The number of requests for a player is summed in column G to give the Demand for a player. Player Demand is converted to a point system that is centered around zero through what is termed an arbitrage system. To center Demand around zero, the sum of Demand (G78) is divided by the number of players (20). This value is the Arbitrage (G25). The arbitrage is subtracted from each player's individual Demand's to produce the valuation based on the arbitrage or Arbitrage Value (AV). This valuing method maintains the integrity of the differences in Demand. A player whom had a demand of 3 is 1 point more valuable than one whose demand is 2 (−1.9 vs. −0.9). As with PickCost and Rank Value more valuable is represented with negative numbers as Teams that acquire more valuable players lose points.

Row 28 through 35 of FIG. 32 illustrates a different way of utilizing demand based data to value a player. This aspect that accents the differences in Demand. It uses the arithmetic sum and the original Ranked Valuations Equation previously described and reiterated below.

Ranked Value=RV=Rank−(Last Rank+1)/2

In this aspect any difference in demand is considered a difference in rank. Those ranked equally are grouped together. The ranks are ordered by demand. Row 30 shows the count of 9 players with Demand of 5. They are treated to encompass the sequential ranks and Rank Values of 1, 2, 3, 4, 5, 6, 7, 8, and 9. The sum of the values of all of those ranks are obtained by the arithmetic sum. Referring to FIG. 23 the Rank Values corresponding to the encompassed ranks 1, 2, 3, 4, 5, 6, 7, 8, and 9 are −9.5, −8.5, −7.5, −6.5, −5.5, −4.5, −3.5, −2.5, −1.5. Their sum being −48. As the Rank Value equation creates an arithmetic sequence of Rank Values, the Arithmetic Sum equation can be used to quickly calculate the sum of a group of consecutive ranks

Arithmetic sum Sₙ=n(a₁+aₙ)/2

When the Rank Value equation is inserted the equation simplifies to the Rank Value Sum RVₙ

RVₙ=n(a₁+aₙ−DP−1)/2

RVn is the sum of a group of continuously ranked players values. a₁ is the rank of the first Player in the series. aₙ is the nth rank. DP is total draft picks.

As the players are indistinguishable, the sum is divided equally between the 9 players in that group to value them at −5.5 (J30).

The next in demand are the players with just 4 teams demanding them. Their a₁ begins where the 5's stopped at 10. As there are five players with that rank, their aₙ is 14. This process is continued through all the possible demands. In this case to the players that were ranked 1. A draft could include any range of demands from 0 up, depending on the system. In this aspect as in the previous the Rank Values are centered around zero to create a closed system that sums to zero (I35).

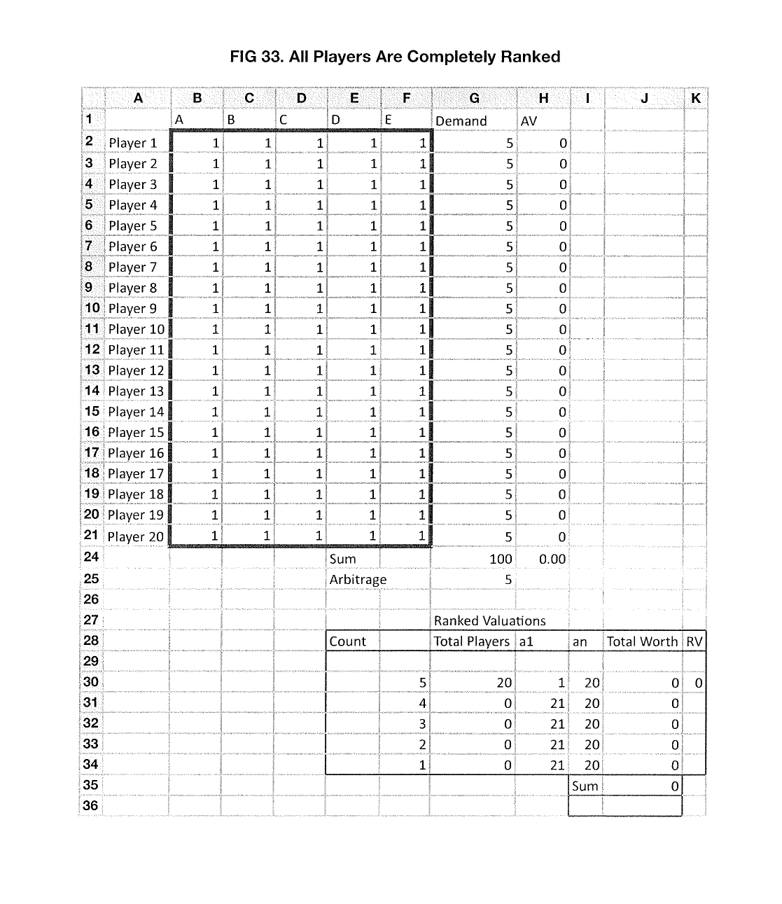

As shown in FIG. 33, when all players are fully demanded, the system has little information to give as all players have the exact same demand. So in this aspect they are all given the same value. Zero.

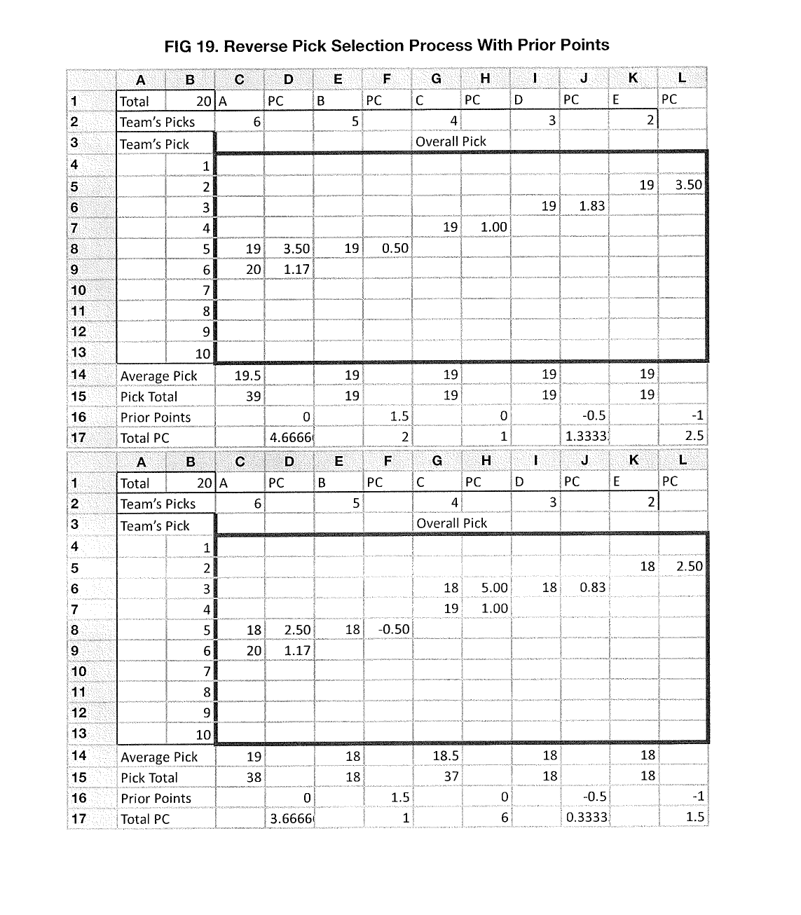

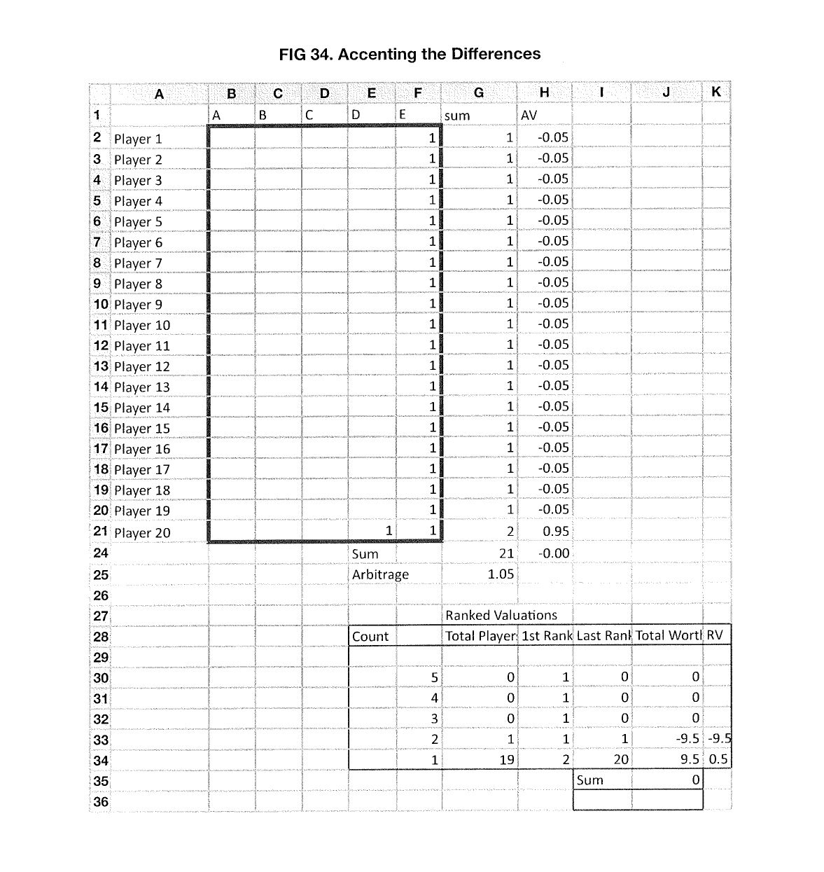

FIG. 34 shows the differences in the two methods. In this FIG. 19 players are ranked 5 and one player is ranked 4, just one rank less. In absolute demand, all players are very similar, but the two methods assign them points very differently. The arbitrage maintains the absolute differences in Demand of 1 (−0.05 vs. 95). But when the Rank Value method is applied to these demand small differences are accentuated. Here the 5's receive −9.5 points and the 4 a 0.5. Each method has uses in the invention depending on the desired effect.

The value of centering the points systems around zero, makes the points more easily relatable between each other. If a system knows that the middle of the road for any points system is zero an all points branch out from there on a linear scale, then a −9 in one system is closer to a −9 in another. This can accomplished with percentages and ratios as well.

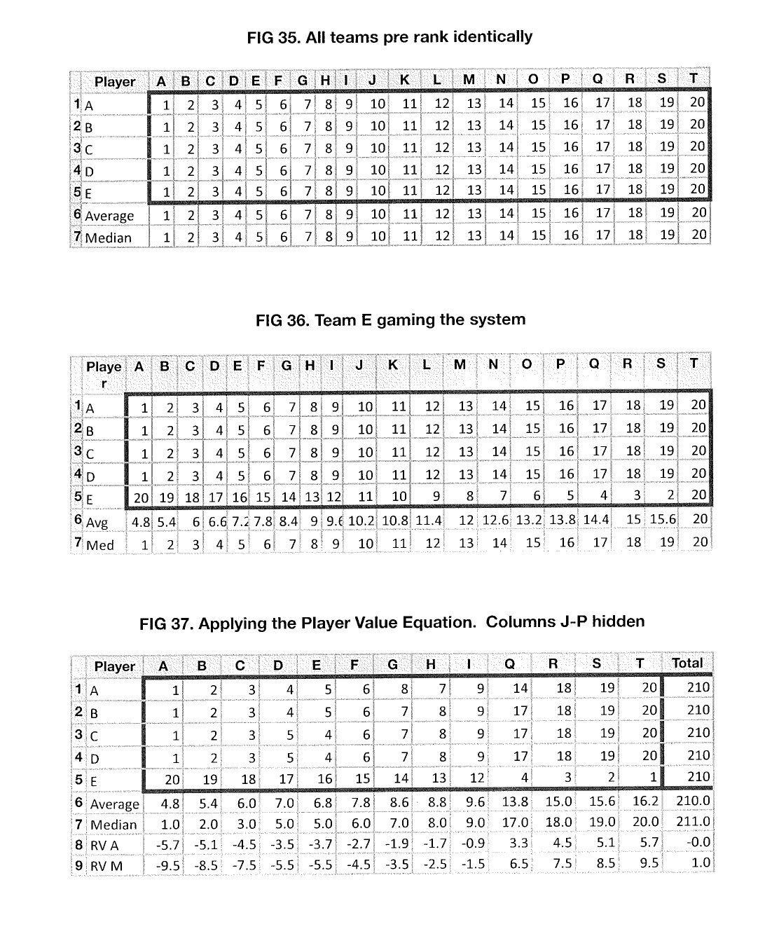

The process of valuing players with ranks versus demand data as described above begins with every team ranking every player. Each rank can only be used once, and every player must be ranked. The rankings range from one to the total number of players in the draft. Hence, team rank lists are created. FIG. 35 demonstrates a draft's pre ranks (row 1-5), where all teams have ranked identically. Hence the median and average for each player is identical (row 6, 7). In FIG. 36 Team E is likely trying to store up points for the next draft and has ranked every player in reverse order. This almost assures Team E will gain a great deal of points when the draft occurs, as all the players it wants are low ranked. In this aspect the use of the Median seems more likely to mimic reality, as it disregards this one rogue ranking team. The average on the other hand ends up very skewed from what most would think the true valuation. In an aspect that wants to encourage gaming and stewardship, using the median is more likely to create the desired effect. Teams do not want to be discouraged from stewardship by their own ranks driving down the value they obtain.

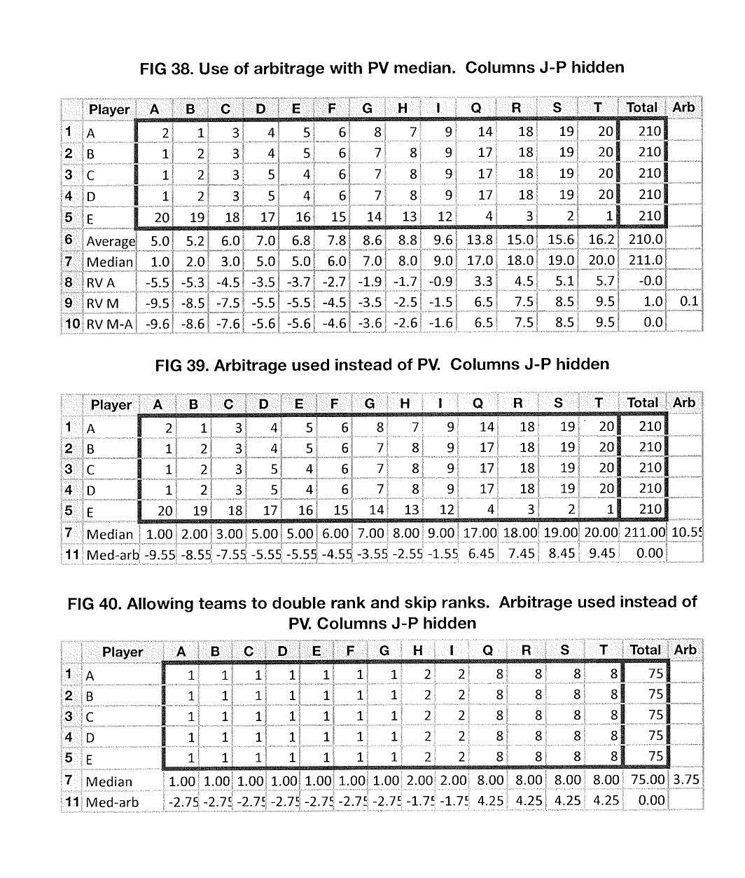

In FIG. 37 values are assigned to the players according to their average rank and median rank and the Ranked Valuations Equation (rows 8 and 9). The Rank Values of the median do not total to zero like the Rank Values for the averages. This is an issue with the use of a median. It is easily corrected with the use of what we are calling the Arbitrage. The Arbitrage process doesn't change the relative values but simply centers them around zero. The arbitrage is the Total of the Rank Value Medians divided by the number of players. The arbitrage is then subtracted from each Rank Value in FIG. 38. The arbitrage is listed in column Arb.

In FIG. 39 the process of finding the Rank Value is skipped altogether and the arbitrage is used to directly value (Med−arb), which matches the values in the figure before which first found the RV of the median, then subtracted the arbitrage.

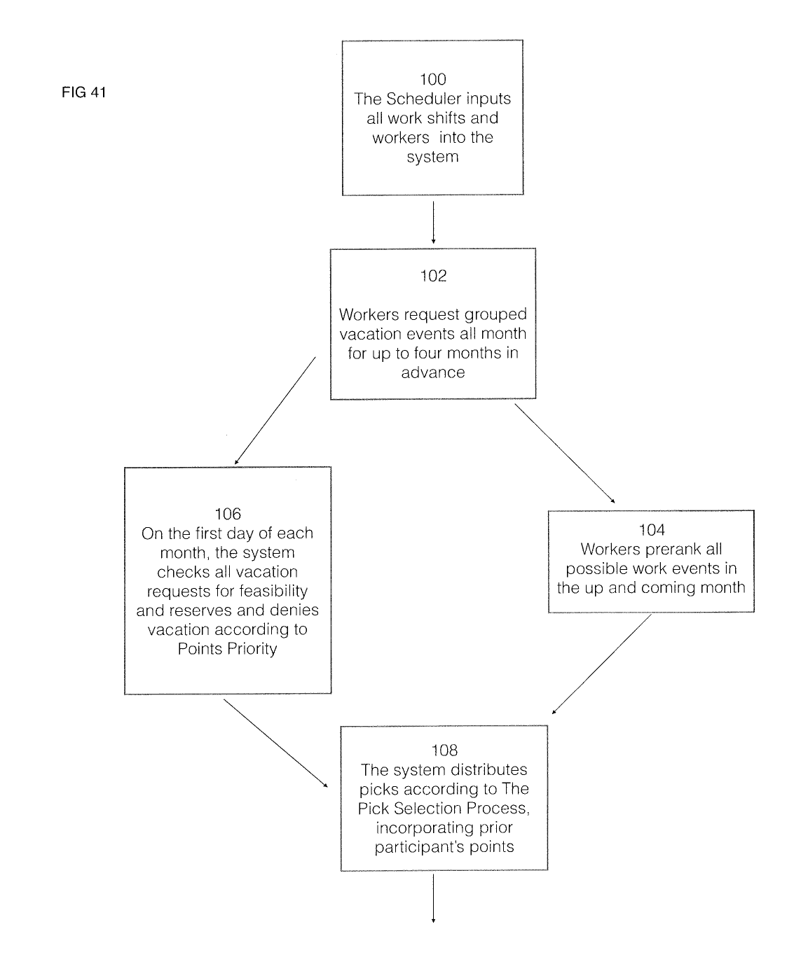

In FIG. 40 an arbitrage is used to find values for the nonsequential and duplicate rankings of players. The values not only sum to zero but also maintain the absolute differences of their ranks This initial data is similar to demand based data.

All of these techniques and a combination thereof can be used to create the desired point system for a system. Other point systems are possible to create the desired pressures on a system and these are offered only as examples. Depending on how much weight one value deserves versus the next, how much differences should be accented, how teams prefer ranking their players, and how the value of said players is thought to be distributed, other can easily be created and someone skilled in the art can manipulate the point system to create the desired effect.

The draft is completed in any myriad of fashions. Teams can participate real time. They can allow rank lists to automate the choosing when it is their turn or combinations thereof. Autodrafting mechanisms can be incorporated that group complimentary players together.

Rules can be predetermined for the draft. They may limit the amount of certain players a team may have or any other myriad of rules. These rules can be checked before the finalization of any selection. If rules are broken, the system can move to the next player on a team's list. If the team is present, it can be notified that that player cannot be drafted because of a rules violation. Preemptively, the system may move all rule breaking players to the bottom of rank lists as soon as they are identified.

The invention is designed for use in most real situations where transparent distribution and stewardship of any resource is desired. A use can easily be imagined in rotating crops in fields, where a farmer wants to track and automate the wear one crop has on a field versus another. A point system valuing airplane flight patterns can be created and drafts be used to balanced wear and tear. Construction work can be organized to optimized machinery and/or workers. Concert tickets can be distributed to reward customers who attend undersubscribed shows with preference on sold out shows. Anything can be a team and anything can be a player.

To illustrate the cooperative and symbiotic uses of the invention, an aspect of the invention dealing with assigning shifts of work and vacation time to employees will be described. In this aspect the teams should be thought of as employees and the shifts of work and vacation time as players. In this aspect there are two drafts that take place each month. A vacation draft for vacation days and a shift work draft for shift work. The vacation draft occurs first. The work draft follows respecting the vacation time granted in the vacation draft before it. The workers do not participate in real time drafting. The shift work is pre ranked completely by every employee from 1 (most desirable) to the least desirable. The vacation time is requested sporadically and is valued via a demand data. The rank data and demand data are converted to point system for feedback on the Pick Selection process. All work and vacation granted add or subtract to the employees Prior Points to skew their picks up or down for the next draft. Prior Points are not affected by the Pick Selection Process and only change values according to the vacation time and shifts of work scheduled. Stated another way, the points generated by the PickCost equation and the Pick Selection process are not carried over in any way. Whatever points a teams enters the Pick Selection process with it leaves with. Points are only added to a team's Prior Points when they are earned by what they select in the work and vacation drafts. Employees are therefore encourage to work lower valued shifts and take less demanded vacations in order to continue to have higher picks in the vacation and work drafts.

Scheduling work of any kind is a time consuming and thankless job. It is normally opaque to almost everyone involved except the scheduler and even they can be overwhelmed quickly when the amount of shifts of work and workers grows over a handful. Few quantitative measures are available to assist the schedulers in how fairly they are scheduling their workers. Few quantitative measures are available to workers to measure how fairly they are being scheduled. Schedulers are stuck trying to give equal shares of every shift of work: weekends, holidays, nights, etc, while catering as best as they can to individual needs and requests. In the end they still end up scrambling and negotiating with workers to schedule holiday, overnight, and last minute holes in schedules. All the while, the workers are not obtaining equal valued shifts despite the best efforts of the manual scheduler.

When the system of scheduling work is examined closely it can be seen that qualitative measures of most shifts of work are obvious to most workers. For example, in some businesses, daytime, weekday work is the easiest and therefore most desired. Weekday night shifts are (roughly) tied with weekend day shifts as less desirable, weekend night shifts even less so, and shifts on a holiday is (again, roughly speaking) twice or three times as bad as a daytime shift. However, in other businesses, preferences may be different. While a weekday daytime shift might be the easiest, a weekend evening shift might be the most lucrative, e.g. in a restaurant. While these qualitative rankings are an approximation, true quantitative and finite comparisons of one shift versus another is more difficult and normally not attempted.

When vacation time is incorporated into a scheduling system, the scheduling becomes even more complex. Few systems assist human schedulers in how many workers are allowed off for any certain time. No known system takes into account the desirability of one vacation period versus another, and no known system rewards workers with more favorable choices in vacation scheduling if they work lesser valued shifts at other times.

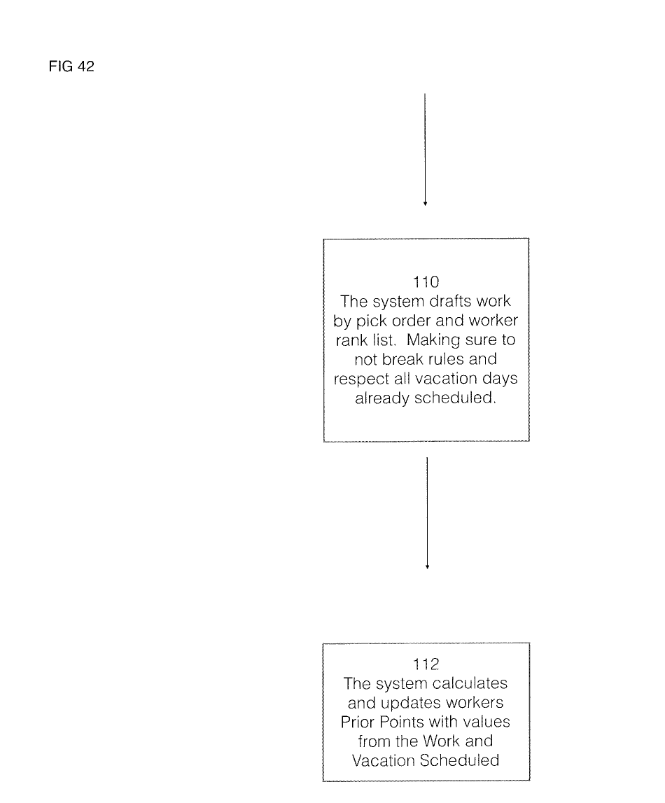

FIGS. 41-42 illustrate a process flow for generating a vacation schedule and work schedule. The process incorporates a system for valuing all vacation requests granted and work scheduled and converting them to a point system. Vacation time is valued proportional to demand and how early requests are made. Shifts of work are valued according to worker rankings of the individual shifts. The valuations of vacation and work are converted to a point system and applied to the workers who are granted or scheduled the vacation or work. The total points of a worker are used to prioritize the worker in vacation and work drafting processes. The entire system works to feed back on itself, so that workers who work less desirable work and take less desirable vacations are rewarded with more choice in their work and vacation.

The initial aspect of any scheduling process is the set up of the system 100. Workers are input into the system by the scheduler along with the necessary work shifts. The worker's name and number of shifts they will work in a month. Shifts of work start and stop times along with the amount of workers needed to work the shift. Other demographic information can be collected for use by the system in data mining ventures.

Step 102 represents the act of requesting vacation time. Workers can request vacation time as soon as one month ahead and as far as five months ahead i.e. in January a worker can request off time in March, April, May, or June. Workers can request off as much time as they want, but will have to pay with points for all that is granted. In another aspect, workers are only allowed to take or request so many days off in a year. Drafts for vacation time occur at the beginning of the month just before the work draft. Workers can request off any combination of days in any of the four available months i.e. in January they can request a week off the second week in March, the 24th and 25th in April, the 5th-8th in May, and the last two weeks in June. All vacation days that are full (from previous drafts or because of lack of availability) are visible to the workers while they make their requests and cannot be requested. Full, is defined as no possible permutation of the schedule would allow for any other worker to have that day off.

Each Vacation day is treated as a separate “player” in the draft and are full twenty-four hour days. Vacation days may be grouped together in any fashion the worker desires. The system grants all or none of the vacation days in a request, but their are no limits to the amount of requests a worker can make in a month's draft except that they cannot be greater than five months ahead. Workers may request one day or groups of days. Worker A for example may request an entire week, weekend, and/or just one day. Participants may request the same exact days off in different permutations i.e. requests for Monday through Sunday, Friday through Sunday, and Saturday can be made on the same week. Through this workers can make choices about what they want and how they want it. One worker may feel that just Saturday off is enough. While a second may prefer the whole weekend off, but will take just Saturday. A third may only want the whole weekend or nothing. The first worker would just request Saturday. The second would have two requests: 1. Saturday 2. Saturday and Sunday. The last worker would just have one request including Saturday and Sunday. Requests are granted according to availability (are there enough workers left to fill the work schedule if the vacation is granted?). Requests are assessed and granted in order of worker point priority.

The vacation draft Block 104 is the vacation draft. It is different than any previous draft described. Workers don't have picks per se, but turns. When it is their turn they are granted all their requests that are feasible. The order of the turn is by points. This means that a worker with more points gets all his vacation requests granted before the worker after him. The draft starts by reserving all vacation days for the highest value worker's first vacation request in the database. It then runs a feasibility check to assess the fillability of all work shifts if that worker is unavailable because of the vacation day(s) encompassed in that request. During this time it takes into account vacation days previously granted for all participants and all work rules. Normal work rules are that no rest is required before or after a vacation, and 8 hours of rest is required before and after a work shift. If the system is able to completely fill all shifts, the vacation request is granted and all feasibility reservations to other workers are erased. The participant's next request is then checked for feasibility and so on. If a request cannot be granted because it is not feasible, it is denied and the next request on the worker's list is checked. After all the highest valued participant's vacation requests have been denied or reserved, the system moves to the second highest valued participant and checks all of her requests. This proceeds until all worker's requests have been checked.

In one aspect, participants will rank requests from less inclusive to more, but this does not have to be the case. All vacation requests that are feasible will be granted regardless of whether they include or overlap with other vacation requests. Vacation requests are treated as “if all” requests whereby they are not granted unless all days in the request can be granted. This is because most vacations are only valuable to the worker if they can get all the days they want i.e. a worker wants to fly to see her grandmother in Phoenix for a week. Getting all days except the Wednesday in the middle off would not be acceptable.

The feasibility check is performed like a real work draft except for a couple of changes to make it run efficiently. As the only purpose of the feasibility draft is to make sure all work shifts can be scheduled, individual worker, rank lists are ignored. Every worker is given the same rank list. The ranklist is crafted to eliminate the possibility of rules violations. In vacation and work drafts, the most common rules are required rest times after a shift. Therefore, this ranklist is in time order, meaning the first shift of the month is ranked first, followed by the second, followed by the third and so forth. This acts to space the shifts out as much as possible in time amongst the workers as the feasibility draft proceeds. This minimizes the chance of a rule being broken, as rules in this aspect are based on time off Prior points are also ignored as the normal Pick Selection Process spaces workers out as much as possible, when Prior Points are not included. With workers picks spaced out as much as possible, and all ranklists order in time order of shifts, the feasibility draft will finish checking for feasibility much faster than a normally ordered draft. If the feasibility draft cannot be completed, the vacation is not granted. All scheduled feasibility shifts are erased, and the next vacation is checked for feasibility. Feasibility drafts can also be used during the shift scheduling process by the schedulers to assure they have enough workers to add new shifts.

Block 112 illustrates calculating the value of vacation events, which are proportional to how early they were reserved and how many other workers requested that particular day off as well. As vacation reservations take precedence over the normal work selection process, they are valued higher than work. Because vacation reservations block vacation requests for the same month once they are granted, they are valued more highly than the reservations for that month that are made less in advance. Simply put, reserving farther in advance costs the participants more points. For example, the system may set up a point system to value a vacation request two months in advance as twice as expensive as a request one month in advance, three months as 3/2 as expensive as one month, and four months is twice as expensive as two months. This trend can be easily reversed in the system if a different system values knowing early whom of its workers will be on vacation. In this aspect the knowing is irrelevant because the system makes sure all work shifts can be fulfilled before granting vacation requests.

Vacation reservations are valued proportional to the amount of requests for that vacation event i.e. a vacation event requested by only half of all participants is worth half as much as one requested by all. Therefore asking off a random day in May will be fairly cheap, but Christmas will be expensive.

For most vacation days, total demand increases as the time to the day nears. When participants know a vacation day is filled (unblinded) they can no longer request it and add to the demand that helps value that day. This further necessitates valuing earlier vacation grants higher, as their true demand will never be known. In another aspect, blinding is utilized for more accurate depictions of demand. The drawback being participants still believing that vacation time is available when it is not.

The points assigned a vacation granted one month in advance that has been requested by everyone in a system (otherwise known as fully requested) is easiest to illustrate. Further and more complicated vacations that are granted earlier and with less requests will be addressed below. The absolute numbers and multiples are presented as an example and each different system will likely determine exactly how to relate demand and the timing of requests to its value system for assigning points to a vacation day granted.

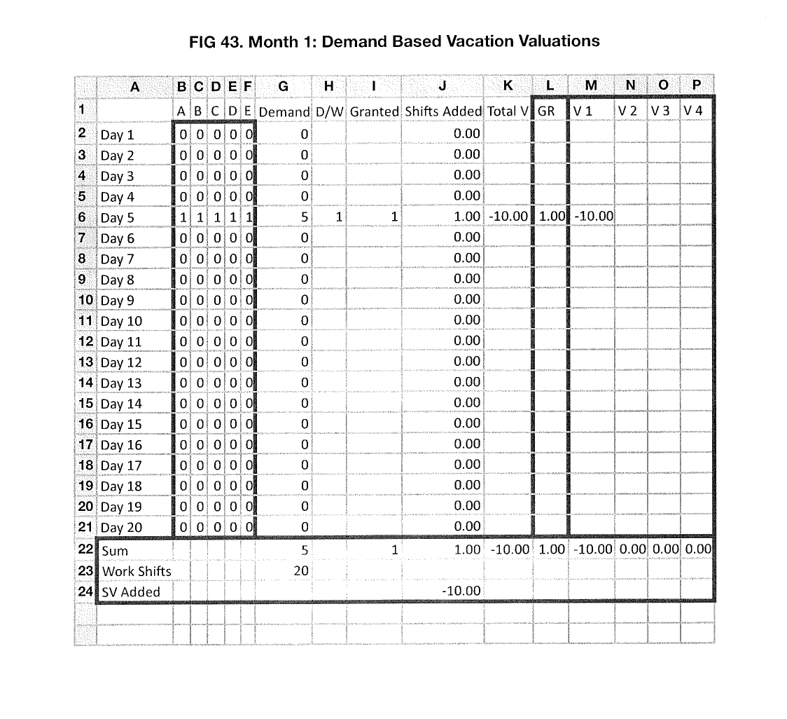

As far as this point system is concerned, all permutations of requesting a vacation event by a participant count for one request. That is, if a participant requests Monday through Friday, Wednesday and Thursday, and Wednesday, this is still thought of as a single request for Wednesday. FIGS. 43-46 represents the 20 days of a month a company works. The company has 5 employees B1 through F1 (A, B, C, D, and E). All workers are part time. The company has one twelve hour shift per day.

In the first month all employees ask for Work Day 5 off. Signified by the “1's” in row 5. Total demand for that day is 5 (G6) and the demand/workers (H6) is 1. Shifts added (column J) is the demand/worker (column H) times the vacations granted (column I) for that day. Shifts added is proportional to the demand and how many workers were granted that day. The demand is translated into shifts, to keep the point system consistent. The idea being, adding a vacation day is the same as adding a new shift to the work draft point system and making that shift the most valuable. The exact numbers and points are arbitrary, but illustrate the idea. The amount of shifts is also proportional to how many workers are granted the day. This is necessary as the point system is predicated on demand and the points assigned should not be diluted because of how many workers are granted the vacation day.

Vacations Granted (Column I) is determined by the vacation draft, and is based solely on availability. As it can be seen, all five workers requested the day off, but only two workers were granted the day off. Shifts added are summed to give the Sum of Shifts added (J22). Shift Added Value is equal to the Sum of the Value of the number of shifts added by Rank Value Sum.
a₁ is equal to 1
aₙ is equal to Sum of Shifts Added.

Using the Rank Value equation and algebraic reduction

Shift Value Added (J23)=(Sum of Shifts added)×(−Work Shifts)/2

This sum is then divided among the vacation days according to the ratio of Shifts Added/Sum of Shifts Added and placed in column K, Total Value for that vacation day. Vacation day's Total Value is divvied up according to the ratio of when requested/granted requests. Granted requests is the total of all requests actually granted. In this first example the Granted Requests is one. As one, one in advance vacation was granted. If two 4 month in advance requests were granted, the Granted Requests would be 8. When requested is when the request was made i.e. 1, 2, 3, 4 months in advance.

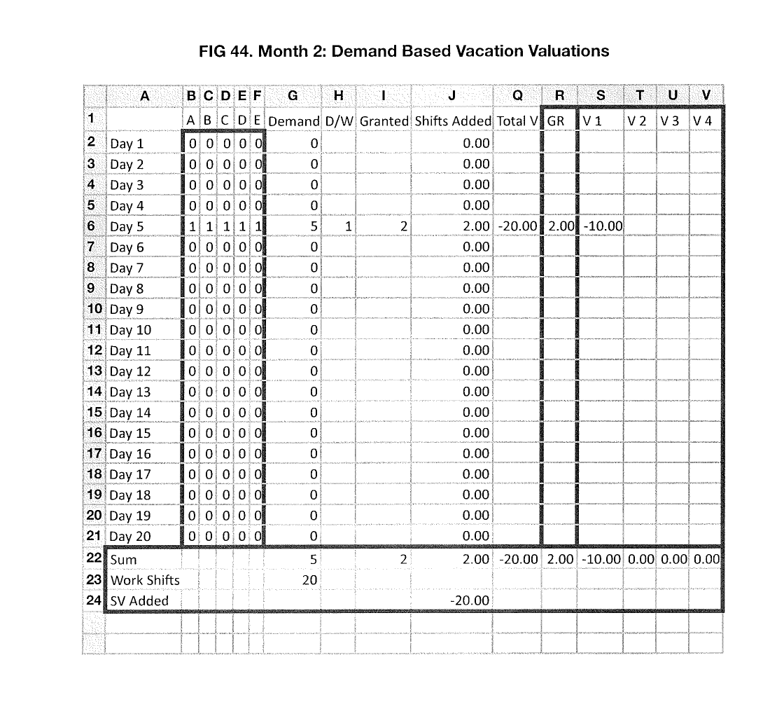

FIG. 44 illustrates the workings of the math as two (16) one month in advance vacation requests are granted. The value of vacation days does not change with the amount granted. The total value of Shift Value Added must double to allow both workers to be charged the points for the vacation.

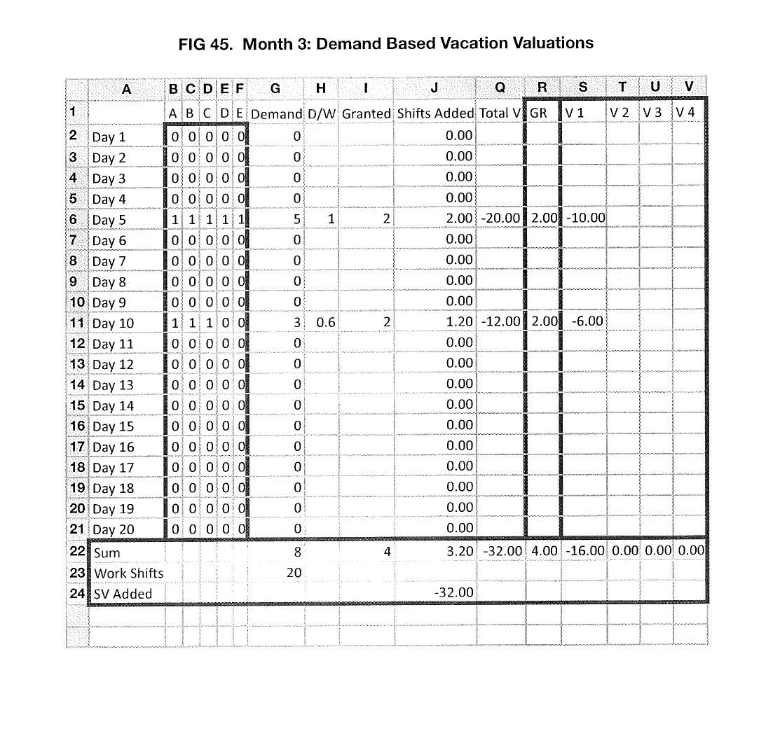

FIG. 45 is similar to FIG. 44 except Work Day 10 receives 3, 1 month prior requests. This adds 1.2 shifts to the Sum of Shifts Added. Of the Shift Value Added, Day 10 receives (1.2)/(3.2) times the total Vacation Value. The two granted days receive 1/(1+1)[(when requested)/(granted requests)] each of the (1.2)/(3.2).

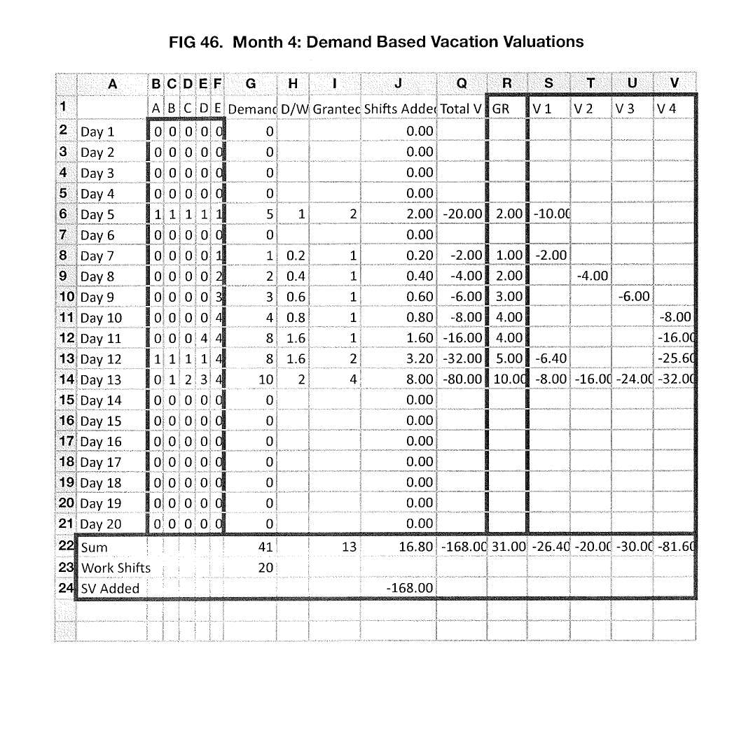

FIG. 46 illustrates the differences in points between solely requested 1, 2, 3, and 4 months in advance in L8, M9, N11, and O11. It doubles when two months out, triples when three months out, and quadruples when four.

Row 11 shows what happens to a vacation value when you double the requests. It doubles the value compared to Row 10. From −8 to −16.

Row 13 shows another aspect of the invention. Vacation requests are granted monthly. Therefore a 4 month in advance request is always granted over a 3 month, a 3 over a 2, and a 2 over a 1. The point system is skewed because of that fact and takes more from the 4 in row 13. There are any myriad of variations on this aspect with requests being worth less or more, divided, multiplied, squared, square rooted, and all possible mathematical manipulations to obtain the most realistic feel.

Returning now to FIGS. 41 and 42, block 106 illustrates the pre ranking of work events before the work selection process, which occurs after vacation shifts have been assigned. Ranking of work events can occur at any time and can have any cycle of time. This aspect requires participants to complete pre ranking of work events by one month prior to the month in which the work event takes place, but other deadlines can be imposed. A participant may rank events in any myriad of ways provided by the system. They can rank every event individually. They can choose another participant's or cohort's rank list. They can use their own prerecorded rankings to reconstruct a rank list for the events provided, the system can suggest a rank list according to previous rankings, or any combination thereof.

Block 108 illustrates the Pick Selection Process that occurs for the work draft. In this aspect the pick ordering is dictated by a participant's points at the time of the process and by how many picks they have. These are used in the previously described Prior Points aspect of the Pick Selection Process to determine the Pick Order. The Pick Selection Process runs in reverse order to optimize the last picks of the draft for those with the most points. As most workers prefer to avoid working the worst days of the month over having their pick of the first days.

When points are tallied, totaled and applied to Prior Picks in the Pick Selection Process is system dependent. Some will chose to apply them as soon as they can be calculated. Others may wait for a year's worth of new points to be accumulated before a worker's Prior Points are changed. All have their own merits and all are easily implemented.

Block 110 is the draft itself where work is scheduled according to the pick order and worker rank list. The system makes sure not to break rules and respects all previously granted vacation time. It moves from worker to worker according to the picks distributed in the Pick Selection process. A worker's pick consists of rules checking the first available work shift on their list and granting it if no rules are broken or skipping it to the next one if they are. If the draft gets to the end of a player's rank list without filling all of their shifts, the draft backs up one pick, forfeits that previous worker's last pick, moves to the next pick on their rank list and begins the process again. This process iterates until a schedule is determined. Systems may allow multiple selections if it is so desired or just one shift of work per pick. This drafting process of scheduling work is much more efficient then the iterative and random process currently in use by scheduling software. In modern autoscheduling systems, a random schedule is generated. It is checked against rules. If it breaks a rule, the process starts over and creates another random schedule. If it does not, it is used. These randomly generated iterations can consume time and resources. By contrast, in accordance with this aspect of the invention, many fewer iterations are required before shifts can be allocated.

Block 112 the system calculates the work and vacation values and applies them to each workers prior points for the next vacation draft and Pick Selection Process for the worker draft. The calculations for this aspect of the invention interweave both demand based and ranking based valuations for vacation days and work shifts. This is accomplished in this aspect by adding vacation shifts to the work shift point system which is a Ranked Valuations point system. They are added as the most valuable shifts. This shifts all work shifts down in value and assures vacation shifts are highly valued, but still relatable to the work shift point system.

RV=Ranked Valuations=Median Rank−(Draft Picks+1)/2

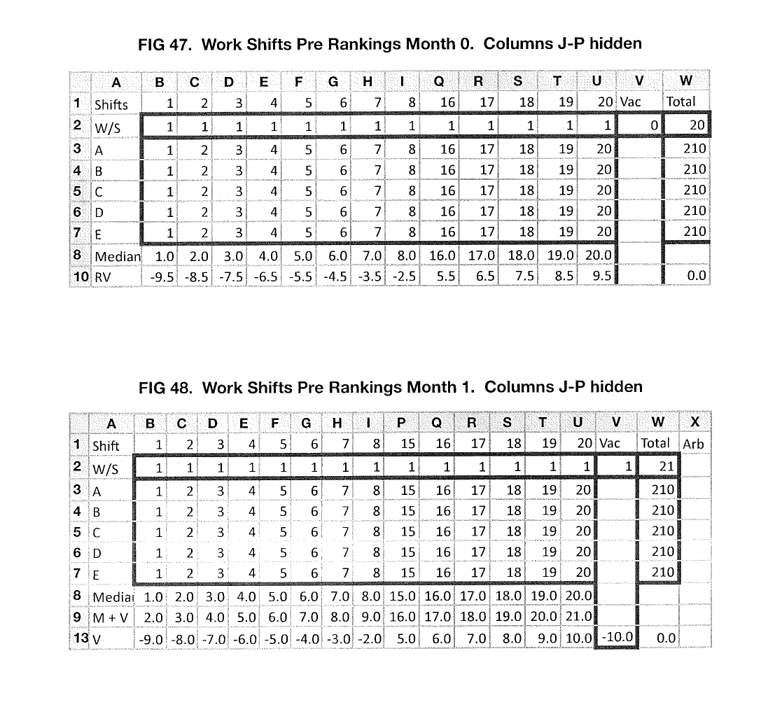

FIG. 47 shows Month 0 in a company with 5 workers (rows 3-7) A, B, C, D, and E; 20 shifts a month (row 1); one worker/shift (row 2). No vacation days have been granted (V2). In this simple example, the median rank is calculated. Then the RV is calculated for that median (row 10). The RV's sum to zero and are ready to be applied to whichever worker's points total is scheduled to work them.

FIG. 48 incorporates one vacation day granted (V2) and the same pre ranks (rows 3-7). In this aspect, the vacation day is thought of as the most valuable “shift” and therefore replaces the highest ranked shift 1 as the number one shift. Subsequently, all other shifts are displaced one higher. In row 9 the one vacation day is added to every shift's median rank. The RV is then calculated using the new median rank+vacation day. The vacation day value is calculated using the sum of continuous Ranked Valuations derived before

Sn=n(a₁+aₙ−DP−1)/2

Sn is the sum of a group of continuously ranked players values.

n is the number of ranks, which is equal to the Vacation Days (VD) added.

a₁ is the first rank in the series.

aₙ is equal to VD as the system is summing all vacation days.

DP is total draft picks.

a1 is 1, as all ranks start at 1, and by definition vacation days are the highest ranked.

As we are valuing Vacation days as the most expensive work shifts the total Draft Picks is the WorkShifts plus the added Vacation Days or

$$\begin{matrix}DP = VD + WorkShifts . \\ \begin{matrix}Vacation Day Value Sum = VD ( 1 + VD - VD - WD - 1 ) / 2 \\ = VD ( - WD ) / 2\end{matrix} & \\ VDV sum = - VD * WD / 2 \\ \begin{matrix}For Month 1 VDV sum = - 1 * ( 20 WorkShifts ) / 2 \\ = - 10 ( V 13 )\end{matrix} & \end{matrix}$$

As desired in this aspect, the sum of all shifts and vacations in the system is zero (W13) and vacation days are the most highly valued. The points can be applied to the Prior Points to balance the Pick Selection Process when the system desires.

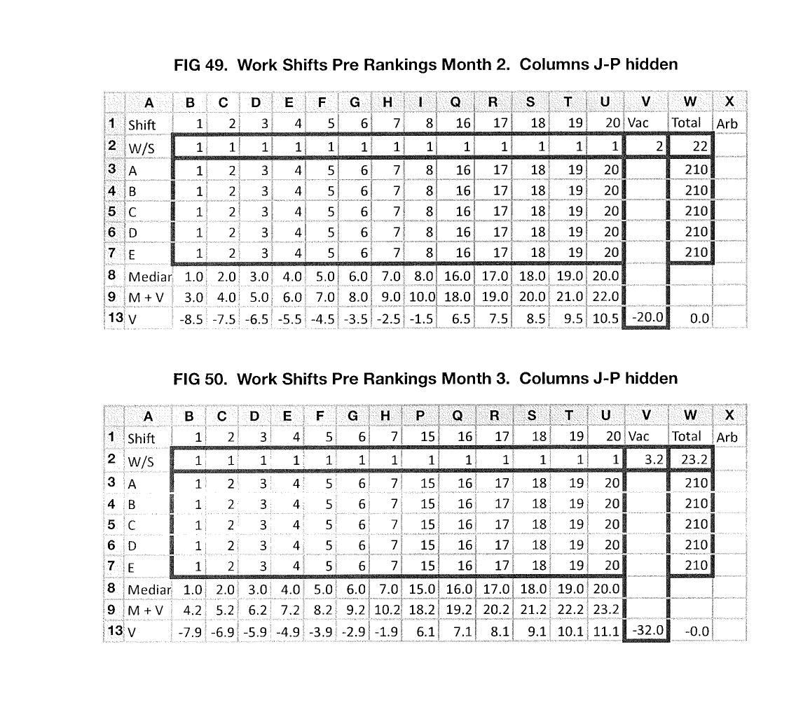

FIG. 49 is similar to Month 1 but two vacation days were granted (V2). The sum of their values is calculated by the VDV sum equation from above at −20 in cell V13. Here the total requests is multiplied by the requests granted to maintain the appropriate points.

FIG. 50 is an example where 3.2 vacation days are added, a fraction of a vacation day. Still the sum of their values is calculated by the VDV sum equation to be −32 and the system sums to zero. The fractional vacation days occur because a full vacation day by definition is one that is demanded by all workers in the draft. If the value is fractionally greater than that or less, partial vacation days are created. The partial days are plugged into the Vacation Day Value Sum equation just as easily as whole numbers. In this aspect the points for a vacation day are proportional to the demand for that day.

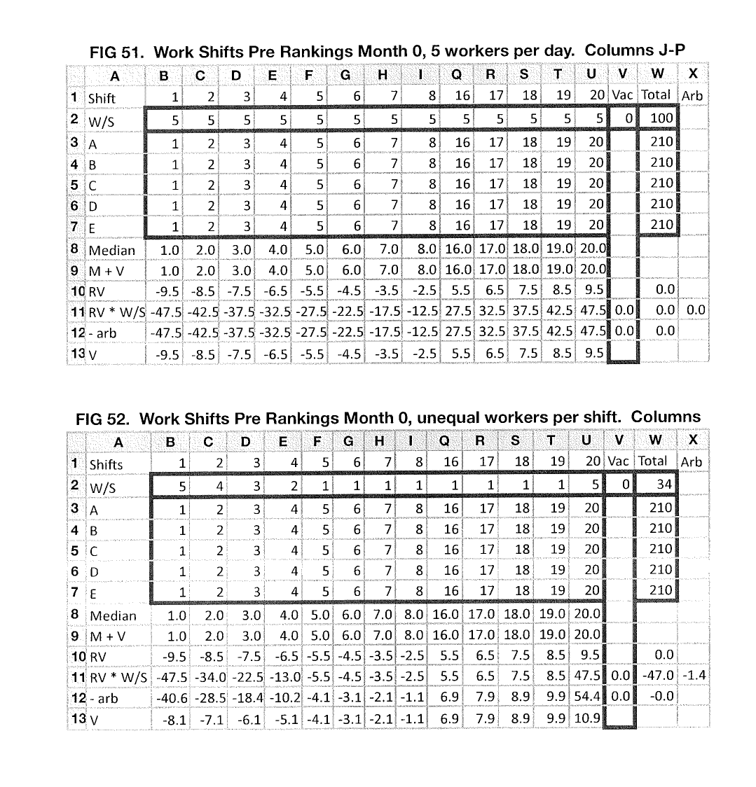

FIG. 51 adds a complication to the calculation. If five workers have to work the exact same shift, they must all receive the same points for the shift. As all five shifts will obtain the same rankings from the worker's, how should the system handle the points. The system also does not know how to value a shift ranked just before or after. An aspect of the invention, dilutes the ranking by dispersing it evenly amongst all the players. This aspect, on the other hand, chooses not to dilute the rankings, and maintains the exact same absolute differences of the ranking relative to other shifts, but adjusts every rank a little. This is another use of an arbitrage-like maneuver. To assure the values still sum to zero an arbitrage is calculated (X11) and used in row 12. RV in row 10 is the same calculation for Value in row 13, but now the arbitrage process in rows 11 and 12 must take place before the end Value in row 13 is formed. In this example the arbitrage just brings the values full circle as the workers per day are equal for every shift.

FIG. 52 shows an example like the previous, but where the arbitrage comes in very handy. Notice the irregularity of workers per shift. Yet they have a smooth progression that parallels the ranks they are derived from after the values are arbitraged. The points all sum to zero, which is valued in this aspect.

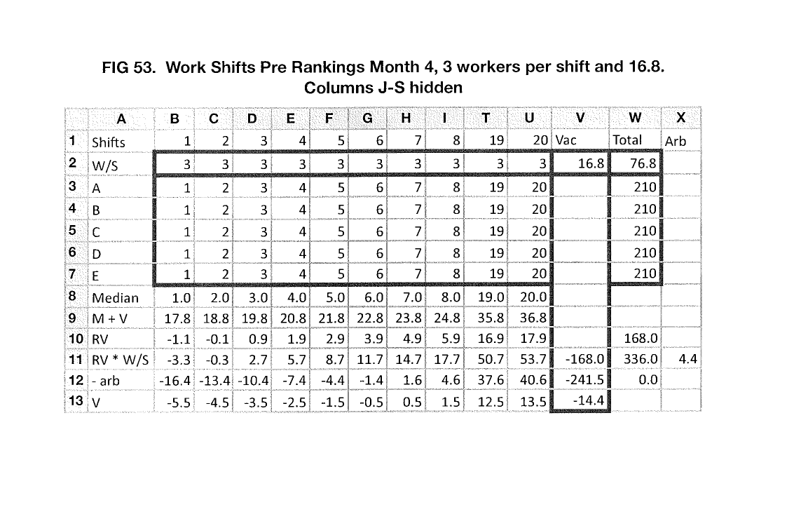

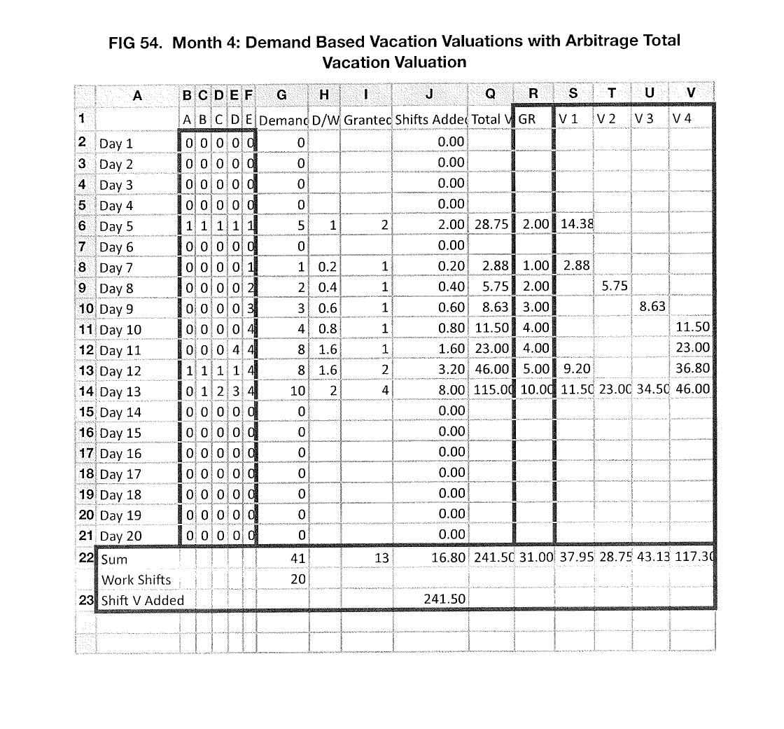

FIG. 53 demonstrates the use of the arbitrage in a very complicated vacation and shift case. It is provided to show that in this aspect the vacation valuations incorporate the after arbitrage Value of Vacations day (V25) if they are necessary. In FIG. 54 241.50 is dispersed throughout the vacation days granted and not 168.

The point systems are not limited to exchange for position in a Pick Selection Process. Certainly they are an earned currency that could be traded for an infinite amount of goods and services. The most obvious being in trade in shifts of work. For example, a worker who needs a Saturday off and trades for a Tuesday, could easily just exchange the point values of the shifts with the other worker. They could also choose to bid up or down the point exchange. Those points gained or lost could then be applied to the Prior Points total to influence Vacation and Work drafts.

Points totals and rank lists are also valuable information to schedulers. With cross referenced demographics, this data could be used to predict future demand, schedule to future demand, match demand for work with customer demand, hire demographics that would likely prefer a groups low valued work, and so on. The point being that accurate demand and rank of a resource along with connected demographic data allows for more targeted operations.

The system has been illustrated using vacation and work schedules. However, persons having skill in the art will realize that the system can be adapted to allocate any type of resource that is to be allocated proportionally to different participants, e.g. concert tickets.

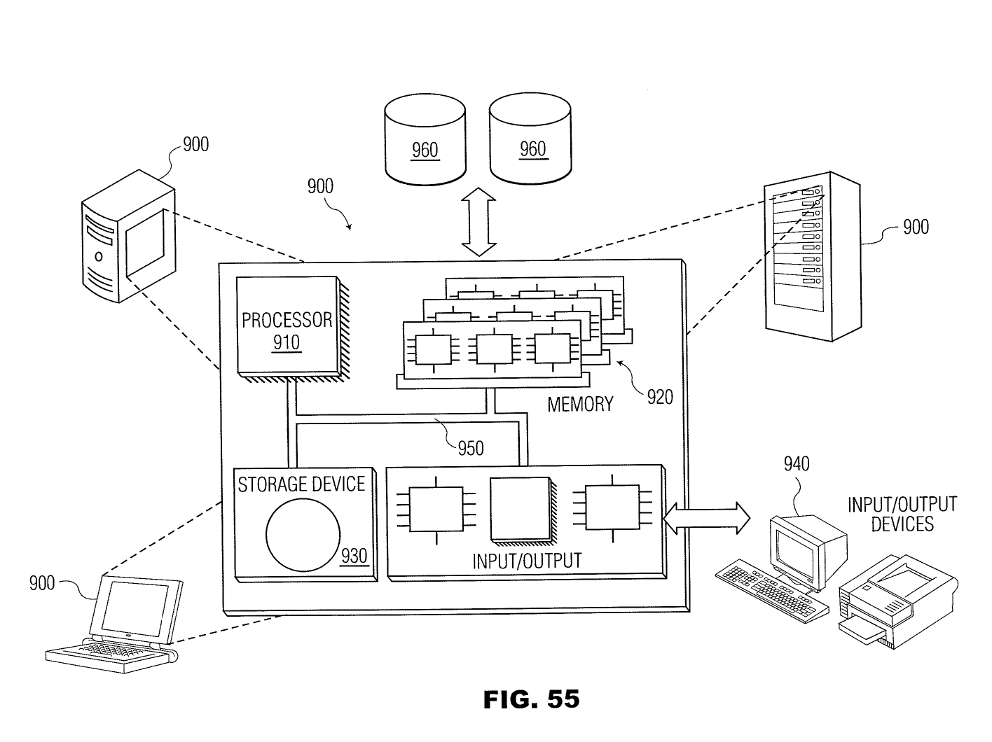

The system is implemented on a computer or server system. FIG. 55 is a diagram displaying a general purpose computer on which the system and method of the present disclosure may be implemented according to an aspect of present disclosure. The computer system 900 may execute at least some of the operations described above. Computer system 900 may include processor 910, memory 920, storage device 930, and input/output devices 940. Some or all of the components 910, 920, 930, and 940 may be interconnected via system bus 950. Processor 910 may be single or multi-threaded and may have one or more cores. Processor 910 may execute instructions, such as those stored in memory 920 or in storage device 930. Information may be received and output using one or more input/output devices 940.

Memory 920 may store information and may be a computer-readable medium, such as volatile or non-volatile memory. Storage device 930 may provide storage for system 900 and may be a computer-readable medium. In various aspects, storage device 930 may be a flash memory device, a floppy disk device, a hard disk device, an optical disk device, or a tape device.

Input/output devices 940 may provide input/output operations for system 900. Input/output devices 940 may include a keyboard, pointing device, and microphone. Input/output devices 940 may further include a display unit for displaying graphical user interfaces, speaker, and printer. External data, such as financial data, may be stored in accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

At this point, while we have discussed and described the disclosure using some specific examples, those skilled in the art will recognize that our teachings are not so limited. Accordingly, the disclosure should be only limited by the scope of the claims attached hereto.

What is claimed is:

1. A computer-implemented system for allocation of a series of picks amongst multiple selectors in a selection process, comprising:
a processor; and
a non-volatile memory in communication with the processor;
the system configured to:
receive input comprising number of picks, number of selectors, and number of picks per selector,
store total picks data corresponding to the number of picks, number of selectors data corresponding to the number selectors, and picks per selector data corresponding to the number of picks per selector;
use the total picks data, the number of selectors data, and the picks per selector data, to determine point values under a points system for allocating pick positions for each selector;
for each selector, allocate picks according to the point system; and
output a pick order.

2. The computer-implemented system of claim 1, wherein said system is further configured to use outside values in addition to the total picks data, the number of selectors data, and the picks per selector data to determine point values.

3. The computer-implemented system of claim 1, wherein said system is further configured to store, for each selector, points accumulated under the points system for use in further iterations of the selection process.

4. The computer-implemented system of claim 1, wherein said system is further configured to
calculate, for each selector, a pick cost for awarding an overall pick to the selector, said pick cost relating to the pick and the point system;
award the overall pick to the selector whose total points when said pick cost is added most closely aligns with the point system; and
repeat the calculation of the pick cost, and the awarding the overall pick to the selector whose total points when the pick cost is added most closely aligns with the point system, for every overall pick represented by the total picks data.

5. The computer-implemented system of claim 4, wherein said pick cost is calculated by comparing the number of the overall pick to a benchmark pick which is calculated based on the total picks data, the number of selectors data, and the picks per selector data in accordance with a benchmark.

6. The computer-implemented system of claim 5 wherein said benchmark is that each participant would have the same average pick value.

7. The computer-implemented system of claim 6 wherein said benchmark is a set of picks corresponding to the same total picks data and picks per selector data that are equidistant from the average pick value and converge on all sequential picks as number of picks per selector approaches number of picks

8. The computer-implemented system of claim 4, wherein a total points for an overall pick that most closely aligns with the point system is a number of total points closest to zero, as compared to a plurality of alternative total numbers of points that would be awarded if the pick were awarded to a different participant.

9. The computer-implemented system of claim 1, said system further configured to select a choice or choices on behalf of each selector in the order of picks awarded.

10. The computer-implemented system of claim 9, said system further configured to select such choice based on data corresponding to a ranking of available choices by each selector.

11. The computer-implemented system of claim 9, said system further configured to
assign a choice value to each choice, and
add the choice value of each selected choice to the total points.

12. The computer-implemented system of claim 9, wherein said choice is a work shift and wherein said selectors are employees, said system further configured to select a vacation choice on behalf of an employee wherein an employee may guarantee not to be allocated a particular work shift, before the selection of shifts in accordance with order of picks awarded.

13. The computer implemented system of claim 12, wherein said vacation is assigned a vacation value, and wherein said system is further configured to use the vacation value along with the total points.

14. The computer implemented system of claim 12, wherein the system is configured to select a choice or choices of vacation on behalf of each selector in order of picks awarded or prior points awarded by the point system.

15. A computer-implemented system for allocating resources amongst multiple selectors in a selection process, comprising:
a processor; and
a non-volatile memory in communication with the processor;
the system configured to:
select a choice on behalf of each selector in an order;
store data related to a value accorded to each choice eligible to be chosen;
allocate points to a selector based upon the value accorded to the choice chosen by the selector;
use the points in a calculation to determine a pick order in future iterations of the selection process; and
output an allocation of resources amongst the selectors.

16. The computer-implemented system of claim 15, wherein the value is calculated based on a popularity of the choice in prior iterations of the selection process.

17. The computer-implemented system of claim 15, wherein the value is calculated based on previously entered preferences by the selectors prior to choices being selected.

18. The computer-implemented system of claim 15, wherein the system is further configured to allow the points can be traded between selectors.

19. The computer-implemented system of claim 15, wherein the value is based on external data.

20. The computer-implemented system of claim 15 wherein the sum of the values of the available choices is zero.

21. The computer-implemented system of claim 15, wherein said system is further configured to select a choice on behalf of each selector based on a previously issued preference of the selector.

22. The computer-implemented system of claim 21, wherein said system is further configured to redo an overall choice in the event that the selector holding the subsequent pick has no ranked choices from which to choose.

23. The computer-implemented system of claim 15, wherein said choice is a work shift and wherein said selectors are employees, said system further configured to select a vacation choice on behalf of an employee wherein an employee may guarantee not to be allocated a particular work shift, before the selection of shifts in accordance with order of picks awarded.

24. The computer-implemented system of claim 23, wherein the system is further configured to determine whether a vacation shift is feasible before awarding the vacation to the selector.

25. The computer implemented system of claim 23, wherein the system is further configured to determine, via a feasibility draft, whether a new work shift can be staffed.

26. The computer-implemented system of claim 23, wherein said vacation is assigned a vacation value, and wherein said system is further configured to use the vacation value along with the points in future iterations of the selection process.

27. The computer-implemented system of claim 15, wherein the system is further configured to aggregate data related to the point system and at least one demographic factor relating to the selectors.
